(19) United States
(12) Patent Application Publication
(10) Pub. No.: US 2018/0349574 A1
(43) Pub. Date: Dec. 6, 2018

(54) APPARATUS AND METHOD TO DISTINGUISH COPIED OPERATING SYSTEMS FROM ORIGINAL ONE

(71) Applicant: FUJITSU LIMITED, Kawasaki-shi (JP)

(72) Inventors: Kenichi Takayanagi, Kawasaki (JP); Shigeaki Koike, Kawasaki (JP); Naoyuki Yoshimi, Kawasaki (JP)

(73) Assignee: FUJITSU LIMITED, Kawasaki-shi (JP)

(21) Appl. No.: 15/988,915

(22) Filed: May 24, 2018

(30) Foreign Application Priority Data
May 30, 2017 (JP) 2017-106731

(51) Int. Cl. G06F 21/12

(52) U.S. Cl. CPC G06F 21/12; G06F 2221/0744

(57) ABSTRACT

An apparatus writes a first identifier and a first management-key of a first operating system (OS) to a first storage-area for the first OS, stores a first record including the first identifier and the first management-key in a memory, and rewrites the first management-key of the first storage-area and the first record as a second management-key at a predetermined timing. The apparatus acquires an identifier and a management-key from a second storage-area for a second OS. The apparatus, when the acquired identifier matches the first identifier and the acquired management-key does not match the second management-key, rewrites the identifier in the second storage-area as a second identifier, rewrites the management key in the second storage-area as a third management-key, and stores a second record including the second identifier and the third management-key for the second OS in the memory.

### CROSS-REFERENCE TO RELATED APPLICATION

This application is based upon and claims the benefit of priority of the prior Japanese Patent Application No. 2017-106731, filed on May 30, 2017, the entire contents of which are incorporated herein by reference.

### FIELD

The embodiments discussed herein are related to apparatus and method to distinguish copied operating systems from original one.

### BACKGROUND

When a company operates a computer system, various problems may occur. The problems are caused by various reasons, such as mistakes in a setting of equipment or a bug in software. Therefore, it is difficult for companies to independently and rapidly respond to all problems that have occurred. Accordingly, there is a service that supports an operation of a computer system.

In the support of the operation of the computer system, there is hardware support and software support. The support for software is executed only for products sold regularly. Since the software is easy to illegally copy, an identification number for an individual specification is set in software, for example. When the software is supported, an operation status of specific software is investigated via a network based on the identification number, it is confirmed that the software is used within a license of use of the software, and then support for the software is performed.

The software to be supported is executed on a virtual machine, in some cases. The virtual machine is a computer system structured on a computer in a pseudo manner. Therefore, as a technique for supporting the software support, there is a technique for tracking and managing copies of virtual machine images and the like from a standpoint of a reseller. In addition, there is also a technique to avoid unauthorized use of the software to be used on the virtual machine.

Japanese Laid-open Patent Publication Nos. 2014-056290 and 2013-131015 are examples of the related art.

### SUMMARY

According to an aspect of the invention, an apparatus includes a memory configured to store a record corresponding to an operating system recognized as being executed on a computer to be managed. When recognizing existence of a first operating system being executed on the computer to be managed, the apparatus writes a first identifier and a first management key corresponding to the first operating system to a first storage area storing setting information of the first operating system, stores a first record including a set of the first identifier and the first management key in the memory, and rewrite the first management key included in each of the first storage area and the first record as a second management key having a value different from that of the first management key at a predetermined timing. When recognizing existence of a second operating system being executed on the computer to be managed, the apparatus acquires an identifier and a management key from a second storage area storing setting information of the second operating system. The apparatus, when a value of the acquired identifier matches a value of the first identifier and a value of the acquired management key does not match the value of the second management key, rewrites the identifier in the second storage area as a second identifier having a value different from that of the first identifier, rewrites the management key in the second storage area as a third management key having a value different from that of the second management key, and stores a second record including a set of the second identifier and the third management key corresponding to the second operating system in the memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a first embodiment;

FIG. 2 is a diagram illustrating a system configuration example of a second embodiment;

FIG. 3 is a diagram illustrating an example of hardware of a computer to be used in the second embodiment;

FIG. 4 is a block diagram illustrating an example of a function of each device of the second embodiment;

FIG. 5 is a diagram illustrating an example of a registry;

FIG. 6 is a diagram illustrating an example of an OS information database;

FIG. 7 is a diagram illustrating an example of a support contract information database;

FIG. 8 is a diagram illustrating an example of a state before software installation;

FIG. 9 is a diagram illustrating an example of a state after software installation and support contract;

FIG. 10 is a first diagram illustrating an example of a registration status of OS information in a management server;

FIG. 11 is a second diagram illustrating an example of the registration status of the OS information in the management server;

FIG. 12 is a third diagram illustrating an example of the registration status of the OS information in the management server;

FIG. 13 is a diagram illustrating an example of an installation status of software after registration in the management server;

FIG. 14 is a diagram illustrating an example of a status of a periodic acquisition of an installation presence or absence flag;

FIG. 15 is a diagram illustrating an example of a state after software installation corresponding to the number of licenses;

FIG. 16 is a diagram illustrating an example of an IP address change status;

FIG. 17 is a first diagram illustrating an example of a support request;

FIG. 18 is a second diagram illustrating an example of the support request;

FIG. 19 is a diagram illustrating an example of coping with a case where a bug occurs in software targeted for support contract;

FIG. 20 is a diagram illustrating an example of coping with a case where the bug occurs in the software different from a support contract target;

FIG. 21 is a diagram illustrating an example of coping with a case where the bug occurs in the software in which the number of the support contracts is equal to or more than the number of targets of the support contract;

FIG. 22 is a diagram illustrating an example of coping with a case where a false OS management number is transmitted and support is received;

FIG. 23 is a diagram illustrating an example of an operation state before copying a virtual machine;

FIG. 24 is a diagram illustrating an example of a state after copying a virtual machine;

FIG. 25 is a diagram illustrating an example of periodic update status of an OS management key;

FIG. 26 is a first diagram illustrating an example of a registration status of other OS information in a case where the OS information is already registered;

FIG. 27 is a second diagram illustrating an example of the registration status of other OS information in a case where the OS information is already registered;

FIG. 28 is a diagram illustrating an example of the periodic update status of the OS management key after shutting off a power source of a server having a copy source OS;

FIG. 29 is a first diagram illustrating an example of an update status of the OS management key accompanying the registration of the OS information after shutting off the power source of the server having the copy source OS;

FIG. 30 is a second diagram illustrating an example of the update status of the OS management key accompanying the registration of the OS information after shutting off the power source of the server having the copy source OS;

FIG. 31 is a diagram illustrating an example of the periodic update status of the OS management key after assignment of registered OS information to a copy destination OS;

FIG. 32 is a first diagram illustrating an example of the registration status of the OS information after restart of the copy source OS;

FIG. 33 is a second diagram illustrating an example of the registration status of the OS information after restart of the copy source OS;

FIG. 34 is a sequence diagram illustrating a first half of a procedure of registration processing of the OS information;

FIG. 35 is a sequence diagram illustrating a second half of the procedure of registration processing of the OS information;

FIG. 36 is a sequence diagram illustrating an example of a procedure of installation information periodic acquisition processing;

FIG. 37 is a sequence diagram illustrating an example of a procedure of OS management key periodic update processing;

FIG. 38 is a flowchart illustrating an example of a procedure of OS management number specification processing;

FIG. 39 is a flowchart illustrating an example of a procedure of encryption file generation processing; and

FIG. 40 is a flowchart illustrating an example of a procedure of support contract confirmation processing.

### DESCRIPTION OF EMBODIMENTS

The advanced software support services are provided only to customers who have signed a service contract. The service contract is made separately for each software. If there is an individual identification number in the software, the software to be a target for the contracted service can be specified by the individual identification number.

On the other hand, the support service targeted for the software that does not have an identification number for individual identification is provided in some cases. In the related art, in a case where there are pieces of software that do not have individual identification numbers, it is difficult to determine whether the support contract is made for each of the pieces of software. For example, it is possible to associate identification information of an operating system (OS) executing the software with the support contract on a one-to-one basis, and to include the software executed on the OS associated with the support contract under the support contract as an application target.

However, in a case where the OS is executed on the virtual machine, it is possible to copy the OS with the entire virtual machine. In this case, information specifying the individual of the OS is also copied. Therefore, even if an identifier for specifying the individual of the OS is assigned to the OS, when the virtual machine is copied, a plurality of Oss each having the same identifier can be recognized from the outside. As a result, the identifier of the OS and the support contract are difficult to be connected on the one-to-one basis.

In order to reliably specify the application target of the support contract, it is important to be able to individually distinguish an OS, as a copy source, from an OS, as a copy destination, as a different OS even in a case where the OS is copied with the entire virtual machine. However, currently, there is no technology to reliably identify individuals of the copied OS. Therefore, in a case where the OS in which the software to be supported is installed is copied with the entire virtual machine, there are pieces of software to be supported simultaneously, and it difficult to distinguish the software pieces from each other.

In one aspect, an object of the present embodiments is to enable individual identification of the OSs between the copy source and the copy destination.

Hereinafter, the present embodiments will be described with reference to the drawings. Each embodiment can be implemented by combining a plurality of embodiments within a scope not inconsistent.

### First Embodiment

A first embodiment will be described.

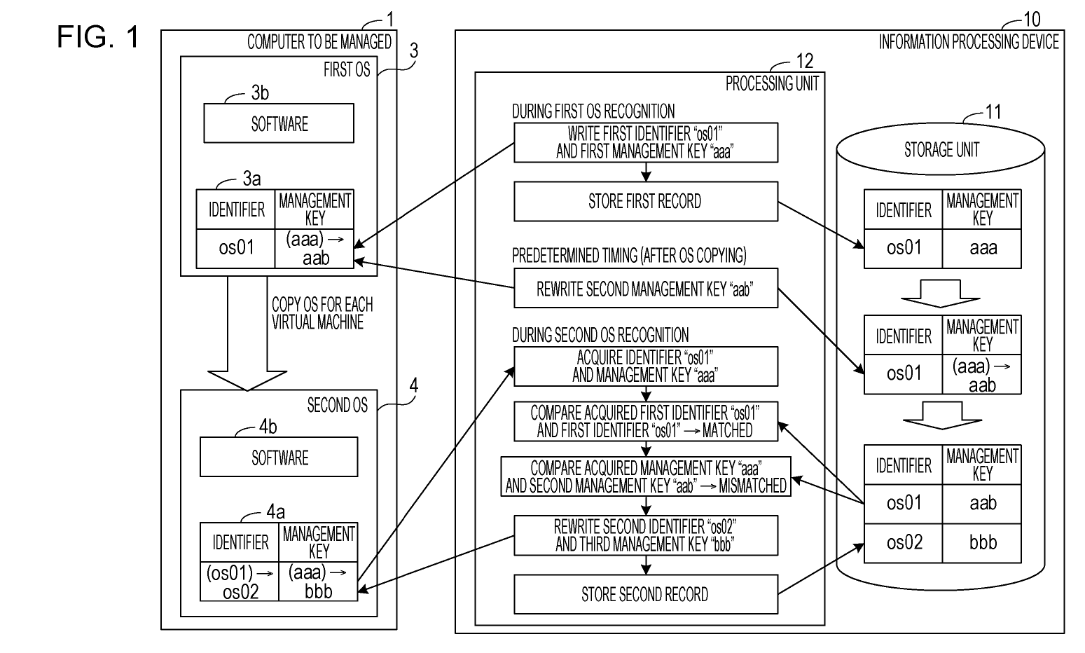

FIG. 1 is a diagram illustrating an example of a configuration of a first embodiment. An information processing device 10 is connected to a computer 1 to be managed via, for example, a network.

The computer 1 to be managed executes a first OS 3 by, for example, a virtual machine. The first OS 3 includes, for example, a registry 3a as a storage area of setting information. In addition, the first OS 3 executes software 3b.

The first OS 3 on the computer 1 to be managed can be copied to a computer 2 to be managed with the entire virtual machine. When the virtual machine is copied, the computer 2 to be managed executes a second OS 4. The second OS 4 includes, for example, a registry 4a as a storage area of setting information. When the copy of the first OS 3 is generated, the software 3b executed in the first OS 3 is also copied, and in the second OS 4 of a copy destination, software 4b copied from the software 3b is executed.

The information processing device 10 includes a storage unit 11 and a processing unit 12. The storage unit 11 is, for example, a memory or a storage device of the information processing device 10. The processing unit 12 is, for example, a processor or an arithmetic circuit included in the information processing device 10.

The storage unit 11 stores a record corresponding to the OS recognized as being executed on the computer to be managed. In the storage unit 11, even for a plurality of OSs generated by copying, records for each of the OSs are stored as separate entities.

For example, when recognizing existence of the first OS 3 executed on the computer 1 to be managed, the processing unit 12 writes a first identifier and a first management key corresponding to the first OS 3 in the storage area of the setting information of the first OS 3. For example, the processing unit 12 recognizes the existence of the first OS 3 by input of a registration request of a record designating the first OS 3. The storage area of the setting information of the first OS 3 is, for example, the registry 3a. In addition, the processing unit 12 stores a first record including a set of the first identifier and the first management key in the storage unit 11. In the example of FIG. 1, the value of the first identifier is “os01” and the value of the first management key is “aaa”.

Thereafter, it is assumed that the first OS 3 is copied with the entire virtual machine to the computer 2 to be managed. The registry 4a of the second OS 4 immediately after copying includes a first identifier having a value “os01” same as that of the first identifier and a third management key having a value “aaa” same as that of the first management key.

The processing unit 12 rewrites the first management keys of the registry 3a of the first OS 3 and the first record as a second management key having a value different from that of the first management keys. In the example of FIG. 1, the first management key is rewritten to the second management key having a value “aab”. For example, the processing unit 12 periodically executes change of the first management key to the second management key at predetermined time intervals. In addition, the processing unit 12 executes the change of the first management key to the second management key after recognizing the existence of the second OS 4 and before changing a second identifier to a third identifier to be described.

When recognizing the existence of the second OS 4 executed on the computer 2 to be managed, the processing unit 12 acquires the second identifier and the third management key corresponding to the second OS 4 from the storage area of the setting information of the second OS 4. The storage area of the setting information of the second OS 4 is, for example, the registry 4a. For example, the processing unit 12 recognizes the existence of the second OS 4 by input of a registration request of the record designating the second OS 4. The processing unit 12 compares the value of the identifier acquired from the second OS 4 with the value of the first identifier stored in the storage unit 11 and compares the value of the management key acquired from the second OS 4 with the value of the second management key stored in the storage unit 11.

In the example of FIG. 1, the value of the acquired identifier matches the value of the first identifier, and the value of the acquired management key does not match the value of the second management key. In this case, the processing unit 12 rewrites the identifier in the registry 4a of the second OS 4 as the second identifier having a value different from the value of the first identifier. In the example of FIG. 1, the identifier having the value “os01” is rewritten to the second identifier with the value “os02”. In addition, the processing unit 12 rewrites the management key in the registry 4a of the second OS 4 as the third management key having a value different from that of the second management key. In the example of FIG. 1, the management key having a value “aaa” is rewritten to the third management key having a value “bbb”.

The processing unit 12 stores a second record including a set of the second identifier and the third management key in the storage unit 11.

In this manner, an identifier different from that of the first OS 3 is assigned to the second OS 4 copied from the first OS 3, and the corresponding individual record is stored in the storage unit 11. That is, even if the OS is copied with the entire virtual machine, the information processing device 10 can recognize the OS as OSs of different entities and assign identifiers to the respective OSs. Enabling individual identification of the OS, for example, by associating the identifier for each OS with a support contract of the software installed in the OS, it is possible to avoid the inquiry of pieces of software for one support contract.

In a case where a function of the first OS 3 stops after copying the OS, it is difficult to rewrite the management key in the registry 3a of the first OS 3. In this case, the first management key in the first record of the storage unit 11 is also not rewritten. In this regard, when the second OS 4 is recognized, the value of the identifier acquired from the second OS 4 matches the value of the first identifier, and the value of the management key acquired from the second OS 4 and the value of the first management key match. In this case, the processing unit 12 rewrites the management key in the registry 4a of the second OS 4 and the first management key in the first record as the third management key having a value different from that of the second management key. Accordingly, when the first OS 3 is restarted later, the management keys of the first OS 3 and the second OS 4 have different values from each other. As a result, the processing unit 12 can recognize the first OS 3 and the second OS 4 as separate entities due to the difference of the management key.

### Second Embodiment

Next, a second embodiment will be described. In the second embodiment, by reliably performing the individual identification of the OS, the support contract relating to the software installed in the OS is appropriately managed by using the identifier assigned to the OS.

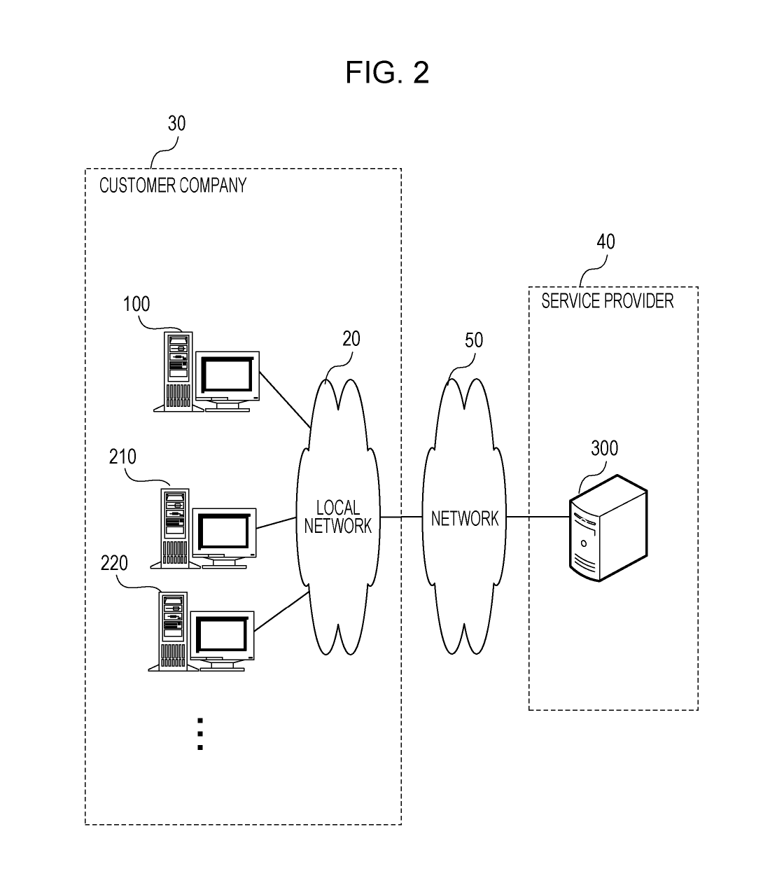

FIG. 2 is a diagram illustrating a system configuration example of a second embodiment. A customer company 30 receives various services relating to the computer system from a service provider 40. For example, the customer company 30 includes a plurality of servers 210, 220, . . . and a management server 100. The servers 210, 220, . . . are computers used for performing work in the customer company 30. The management server 100 is a computer that supports management of contracts of support services for software installed in the servers 210, 220, . . . .

The servers 210, 220, . . . and the management server 100 are connected to each other via a local network 20. In addition, the customer company 30 purchases the software to be installed in each of the servers 210, 220, . . . from the service provider 40, for example. The customer company 30 receives the support service of the purchased software from the service provider 40. For example, a user of the customer company 30 generates an encryption file for confirming that the support contract is applicable using the management server 100 connected to the local network 20. The user of the customer company 30 sends the generated encryption file to the service provider 40 and requests the support service.

The service provider 40 includes a support contract management server 300. The support contract management server 300 is a computer that manages a support license of the software sold to the customer company 30. The support contract management server 300 is connected to the local network 20 of the customer company 30, for example, via a wide area network 50. The support contract management server 300 can receive the encryption file generated by the management server 100 via the network 50, for example. The support contract management server 300 confirms the presence or absence of the support contract for the software to be supported on based on the encryption file provided from the customer company 30. In a case where it is confirmed that there is the support contract, a service representative of the service provider 40 implements a software support service to the customer company 30.

The servers 210, 220, . . . illustrated in FIG. 2 are examples of the computers 1 and 2 to be managed discussed in the first embodiment. In addition, the management server 100 illustrated in FIG. 2 is an example of the information processing device 10 discussed in the first embodiment.

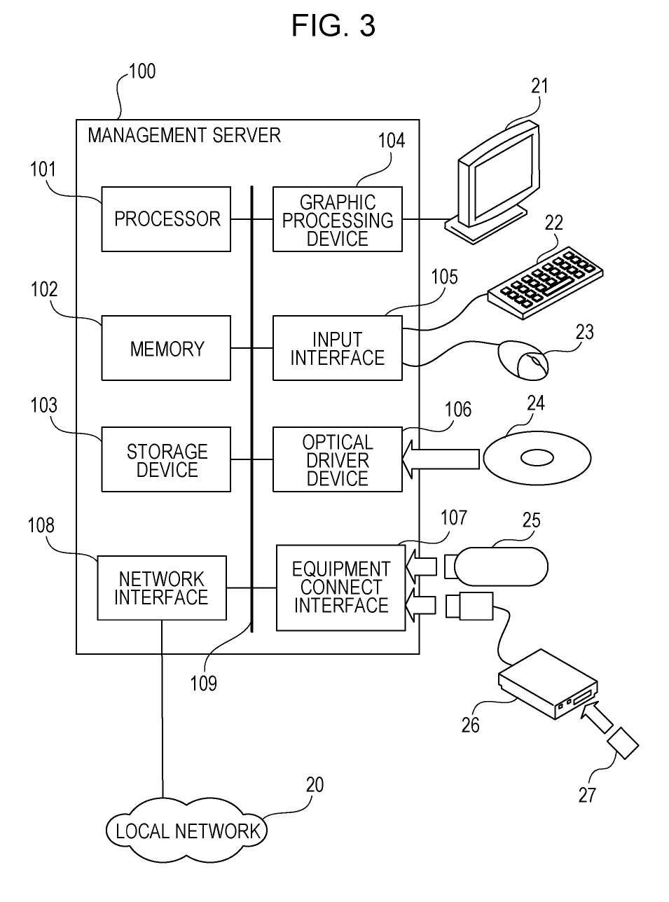

FIG. 3 is a diagram illustrating an example of hardware of a computer to be used in the second embodiment. In the management server 100, the entire device is controlled by a processor 101. A memory 102 and a plurality of peripheral devices are connected to the processor 101 via a bus 109. The processor 101 may be a multiprocessor. The processor 101 is, for example, a central processing unit (CPU), a micro processing unit (MPU), or a digital signal processor (DSP). At least a part of the functions realized by the processor 101 executing the program may be realized by electronic circuits such as an application specific integrated circuit (ASIC) and a programmable logic device (PLD).

The memory 102 is used as a main storage device of the management server 100. In the memory 102, at least a part of the OS program and the application program to be executed by the processor 101 is temporarily stored. In addition, in the memory 102, various data items desired for processing by the processor 101 are stored. As the memory 102, for example, a volatile semiconductor memory device such as a random access memory (RAM) is used.

The peripheral devices connected to the bus 109 include a storage device 103, a graphic processing device 104, an input interface 105, an optical drive device 106, an equipment connect interface 107, and a network interface 108.

The storage device 103 writes and reads out data electrically or magnetically to a built-in recording medium. The storage device 103 is used as an auxiliary storage device of a computer. The storage device 103 stores the programs of the OS, application programs, and various data items. As the storage device 103, for example, a hard disk drive (HDD) or a solid state drive (SSD) can be used.

A monitor 21 is connected to the graphic processing device 104. The graphic processing device 104 displays an image on the screen of the monitor 21 according to a command from the processor 101. Examples of the monitor 21 include a display device, a liquid crystal display device, or the like using a cathode ray tube (CRT).

A keyboard 22 and a mouse 23 are connected to the input interface 105. The input interface 105 transmits signals sent from the keyboard 22 and the mouse 23 to the processor 101. The mouse 23 is an example of a pointing device, and other pointing devices can also be used. Other pointing devices include a touch panel, a tablet, a touch pad, a track ball, and the like.

The optical drive device 106 reads data recorded on an optical disc 24 using a laser beam or the like. The optical disc 24 is a portable recording medium on which data is recorded so as to be readable by reflection of light. As the optical disc 24, there are a digital versatile disc (DVD), a DVD-RAM, a Compact Disc Read Only Memory (CD-ROM), a CD-R (Recordable)/RW (ReWritable), and the like.

The equipment connection interface 107 is a communication interface for connecting the peripheral devices to the management server 100. For example, a memory device 25 or a memory reader and writer 26 can be connected to the equipment connection interface 107. The memory device 25 is a recording medium provided with a communication function with the equipment connect interface 107. The memory reader and writer 26 is a device that writes data to a memory card 27 or reads the data from a memory card 27. The memory card 27 is a card type recording medium.

A network interface 108 is connected to the local network 20. The network interface 108 exchanges data with other computers or communication devices via the local network 20.

By the above-described hardware configuration, the processing function of the second embodiment can be realized. The servers 210, 220, . . . and the support contract management server 300 can also be realized by the same hardware as the management server 100 illustrated in FIG. 3. In addition, the information processing device 10 discussed in the first embodiment can also be realized by the same hardware as the management server 100 illustrated in FIG. 3.

The management server 100 realizes the processing function of the second embodiment by executing, a program recorded on a computer readable recording medium, for example. A program describing processing contents to be executed by the management server 100 can be recorded on various recording media. For example, a program to be executed by the management server 100 can be stored in the storage device 103. The processor 101 loads at least a part of the program in the storage device 103 into the memory 102 and executes the program. In addition, a program to be executed by the management server 100 can be recorded in a portable recording medium such as the optical disc 24, the memory device 25, the memory card 27, or the like. The program stored in the portable recording medium can be executed after being installed in the storage device 103, for example, under the control of the processor 101. In addition, the processor 101 can read and execute the program directly from the portable recording medium.

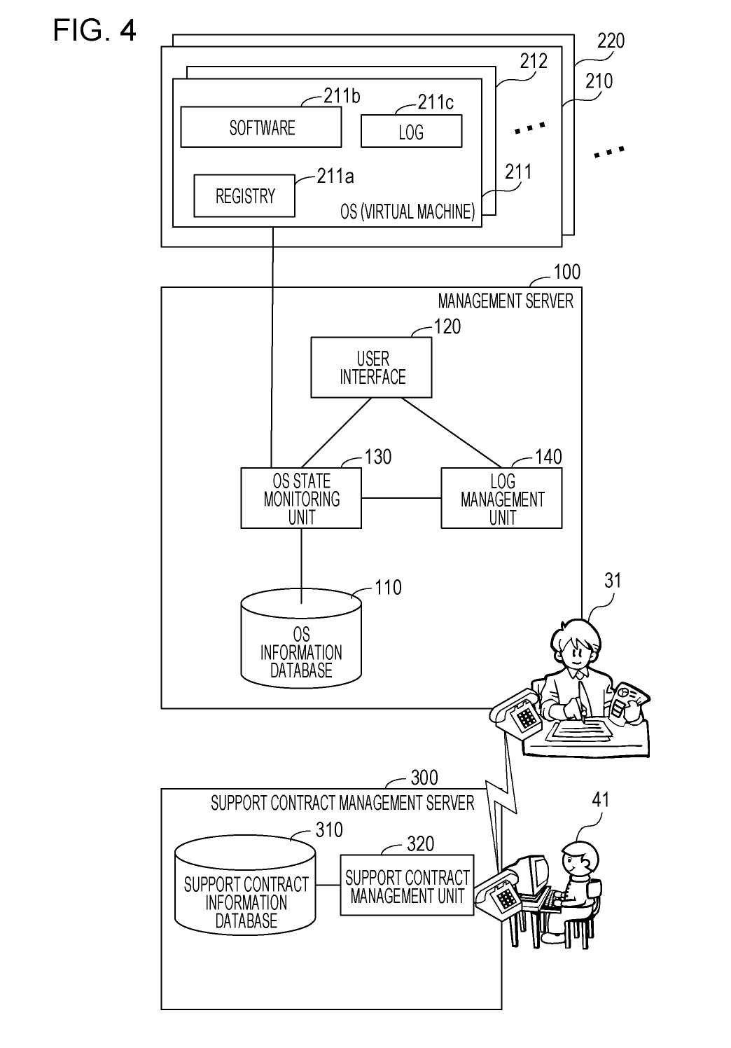

FIG. 4 is a block diagram illustrating an example of a function of each device of the second embodiment. Each of the servers 210, 220, . . . , executes one or more OSs. For example, the server 210 executes a plurality of OSs 211, 212, . . . . Execution of the plurality of OSs 211, 212, . . . can be realized by using a hypervisor, for example. For example, the server 210 constructs a plurality of virtual machines (VM) in the server 210 using the hypervisor. The server 210 causes each of the plurality of virtual machines constructed to execute the OSs 211, 212, . . . .

The OS 211 executed in the server 210 includes a registry 211a. The registry 211a is a database for storing setting information in the OS 211. In addition, the OS 211 can install a software 211b to be managed by the software support contract. When the OS 211 executes the software 211b, a log 211c for accumulating messages indicating various events occurring during execution of the software 211b is generated. The log 211c includes, for example, an error message indicating an error occurred while executing the software 211b. The error message includes, for example, an error code indicating the type of error.

Not only the OS 211 but also an OS executing on any one of the servers 210, 220, . . . includes a registry similar to the OS 211, and in a case where the software is executed, the OS includes a log corresponding to the software.

The management server 100 includes an OS information database 110, a user interface 120, an OS state monitoring unit 130, and a log management unit 140.

The OS information database 110 is a database for storing information on the OSs operating on the servers 210, 220, . . . . For example, the memory 102 of the management server 100 or a part of the storage area of the storage device 103 is used as the OS information database 110.

The user interface 120 receives input from a user 31 in the customer company 30 and displays processing results in accordance with the input.

The OS state monitoring unit 130 monitors the state of the OS operating on the servers 210, 220, . . . . For example, the OS state monitoring unit 130 assigns an OS management number and an OS management key to each OS. The OS management number is an identifier of the OS. The OS management key is, for example, an array of randomly generated letters, numbers, and symbols. For example, the OS state monitoring unit 130 remotely logs in to the OS 211 and stores the OS management number and the OS management key of the OS 211 in the registry 211a of the OS 211. The OS state monitoring unit 130 manages the state of the OS by using the OS management number and the OS management key.

The log management unit 140 manages the log output by the software in the servers 210, 220, . . . . For example, the log management unit 140 acquires the log of one of the servers via the OS state monitoring unit 130, and encrypts the log. For example, the log management unit 140 performs encryption using a public key provided from the service provider 40. The encrypted log is handed over to a support representative 41 in the service provider 40 as a record of the trouble contents at the time of the support request by the user 31.

The support contract management server 300 includes a support contract information database 310 and a support contract management unit 320.

The support contract information database 310 stores information on support contracts concluded with the customer company 30. For example, the memory of the support contract management server 300 or a part of the storage area of the storage device is used as the support contract information database 310.

The support contract management unit 320 receives the input from the support representative 41 in the service provider 40 to the support contract information database 310 and displays the processing results on the support contract information database 310 according to the input. In addition, the support contract management unit 320 decrypts the encrypted file. For example, the support contract management unit 320 decrypts the log of the software in which the bug occurred and encryption data obtained by encrypting the OS management number of the OS in which the software is installed, with a secret key of the service provider 40. Furthermore, the support contract management unit 320 refers to information such as a log obtained by decryption and performs processing of confirming whether the software is the software of the support target in the support request from the user 31 is a target of the support contract.

Next, the information managed by each device will be specifically described.

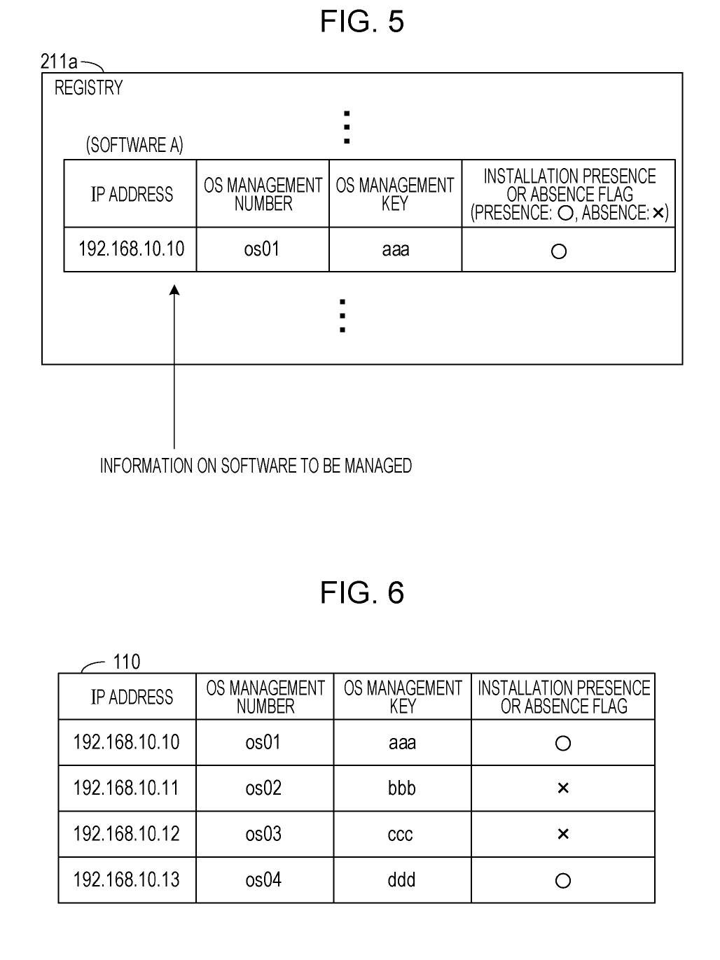

FIG. 5 is a diagram illustrating an example of a registry. In the registry 211a of the OS 211, information on an environment setting of the OS 211 and the environment setting of the software installed in the OS 211 is set. Among the information set in the registry 211a, an IP address, an OS management number, an OS management key, and an installation presence or absence flag are included as information related to the software 211b. These information items are registered in the registry 211a in association with a product name “software A” of the software 211b, for example.

The IP address in the information on the software 211b is the IP address of the OS 211. The OS management number in the information on the software 211b is an identification number for uniquely identifying the OS within the customer company 30. In a case where a copy of the OS is generated, the OS management key in the information on the software 211b is data used for distinguishing the plurality of OSs generated by copying. The installation presence or absence flag in the information on the software 211b is a flag indicating whether the software 211b is installed in the OS 211. In the example of FIG. 5, in a case where the software 211b is installed, a circle is set in the installation presence or absence flag, and in a case where the software 211b is not installed, it is assumed that the install flag is set in the installation presence or absence flag. For example, the circle is replaced with the value of “1” and stored on the data, and a bullet is replaced with the value “0” and stored.

FIG. 6 is a diagram illustrating an example of an OS information database. In the OS information database 110, information on the software in the corresponding OS is stored in the record for each OS executed in the servers 210, 220, . . . . For example, each record in the OS information database 110 includes the IP address, the OS management number, the OS management key, and the installation presence or absence flag.

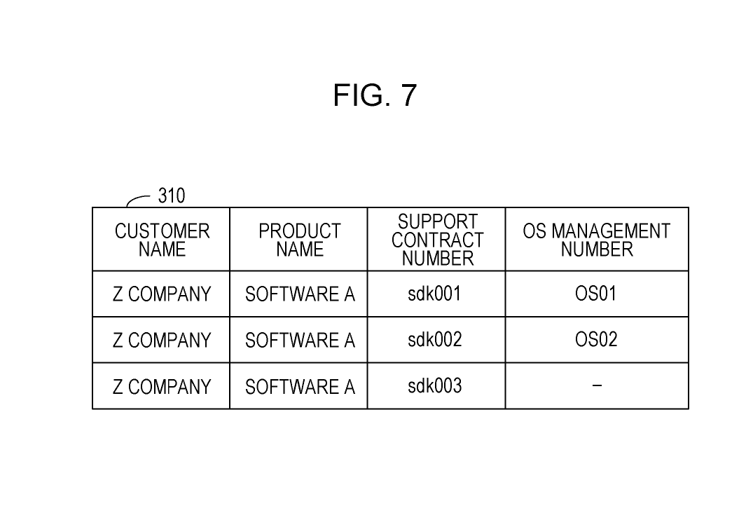

FIG. 7 is a diagram illustrating an example of a support contract information database. In the support contract information database 310, information on the support contract is stored in the record for each support contract for one software with the customer company. For example, each record in the support contract information database 310 includes a customer name, a product name, a support contract number, and an OS management number. The customer name is the name of the customer who concluded the support contract. The product name is the product name of the software to be supported. The support contract number is an identification number for identifying a support contract for each software. The OS management number is the identification number of the OS in which the software to be supported is installed. The OS management number is not set (blank) for the record relating to the support contract for which the software to be supported is not confirmed.

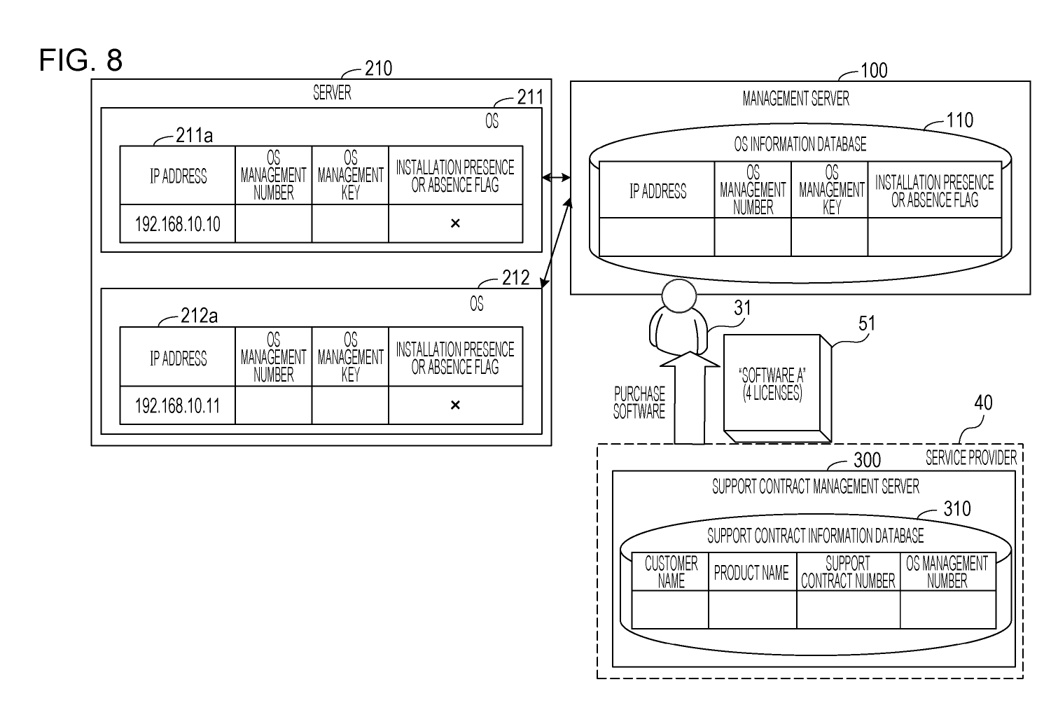

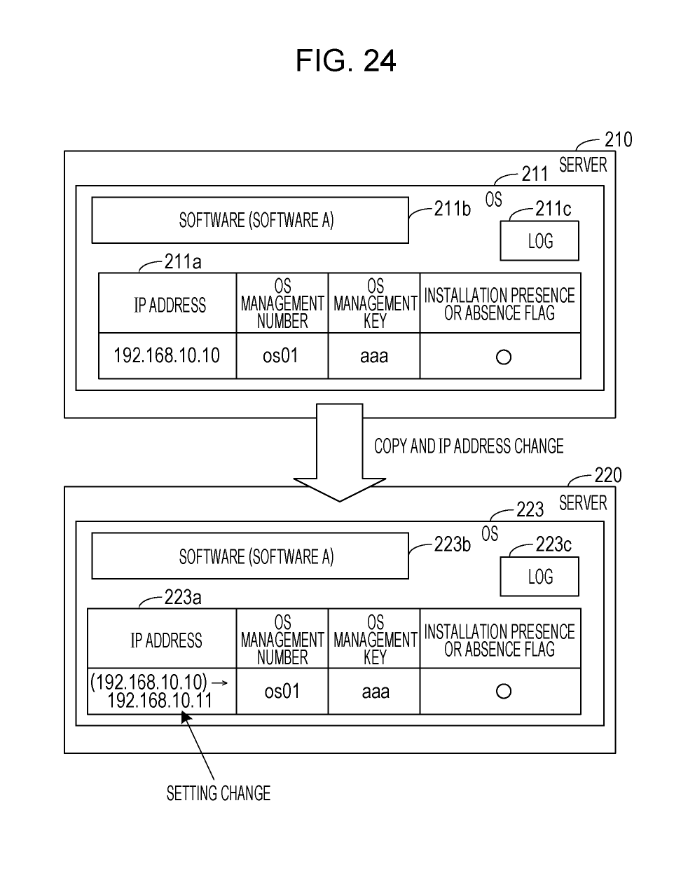

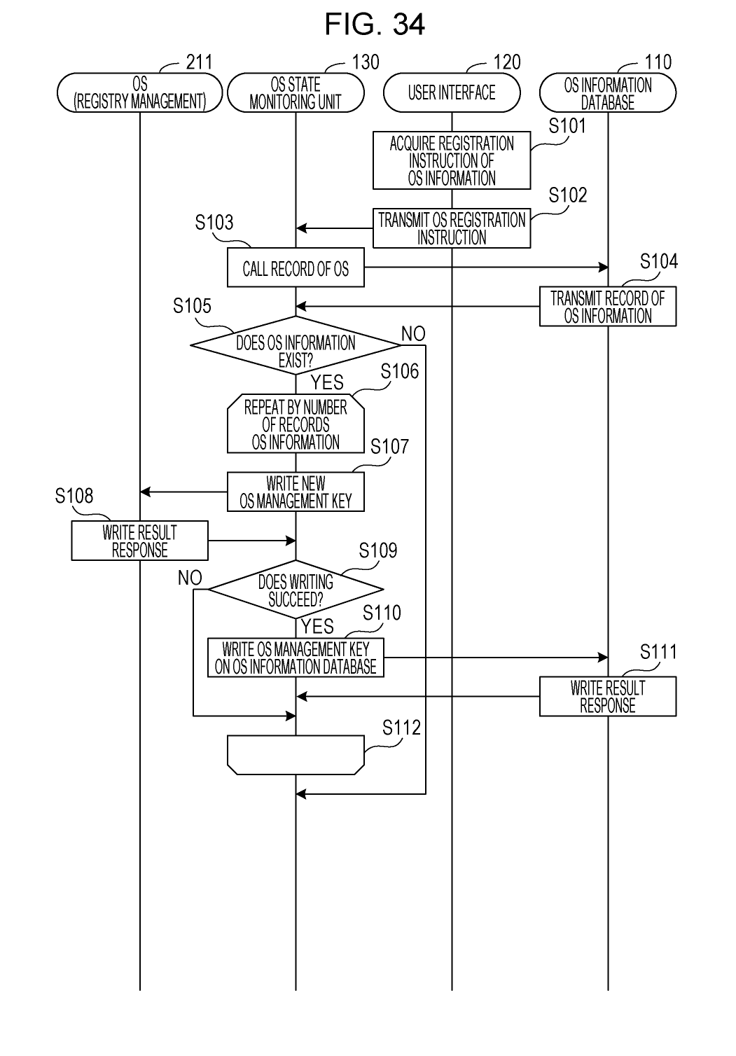

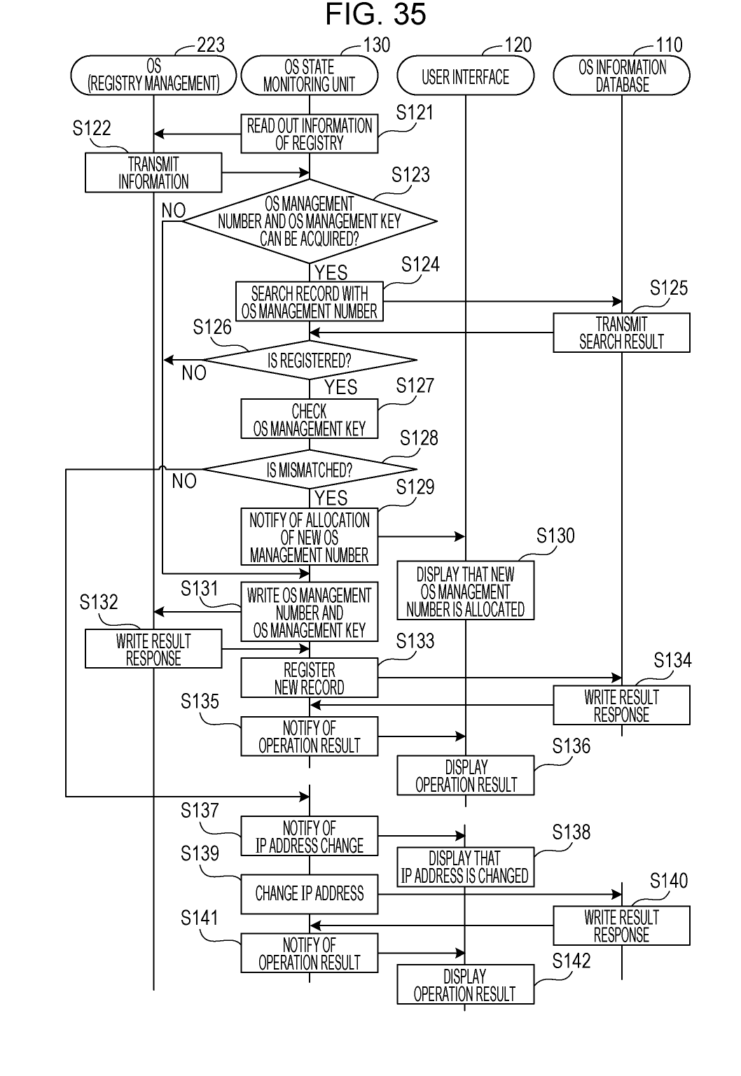

The management of the support contract for the software is performed using the above-described data. In the following description, firstly, a basis procedure for the customer company 30 to conclude the support contract for the software with the service provider 40 and receive provision of the support service will be described with referring to FIGS. 8 to 23. Thereafter, a coping procedure in the case where the virtual machine including an OS is copied will be described with referring to FIGS. 24 to 33. Finally, the overall processing procedure of the support contract management processing assuming the case where the virtual machine including an OS is copied will be described with reference to FIGS. 34 to 40.

Provision Procedure of Support Service

Firstly, a procedure for supporting software within the scope of the support contract will be described to the customer company 30 without assuming the case where the virtual machine including an OS is copied.

FIG. 8 is a diagram illustrating an example of a state before software installation. For example, the user 31 purchases a software package 51 from the service provider 40. In the software package 51, the number of OSs that can be installed is indicated by the number of licenses. In the example of FIG. 8, the license number of the software package 51 is “4”. That is, the customer company 30 has the right to install software using the software package 51 for the four OSs.

The software package 51 is, for example, a computer readable recording medium. In addition, the user 31 can receive only electronic data as the software package 51 via the network 50. At this stage, software to be managed is not installed on any server. Therefore, for example, in the registries 211a and 212a of the OSs 211 and 212 in the server 210, an installation presence or absence flag indicating that there is no installation is set.

The user 31 of the customer company 30 who purchased the software package 51 installs the software in one of the OSs in the servers 210, 220, . . . , using the software package 51, and performs information processing using the software. In addition, the customer company 30 can also receive provision of the software support services from the service provider 40 by making a software support contract with the service provider 40.

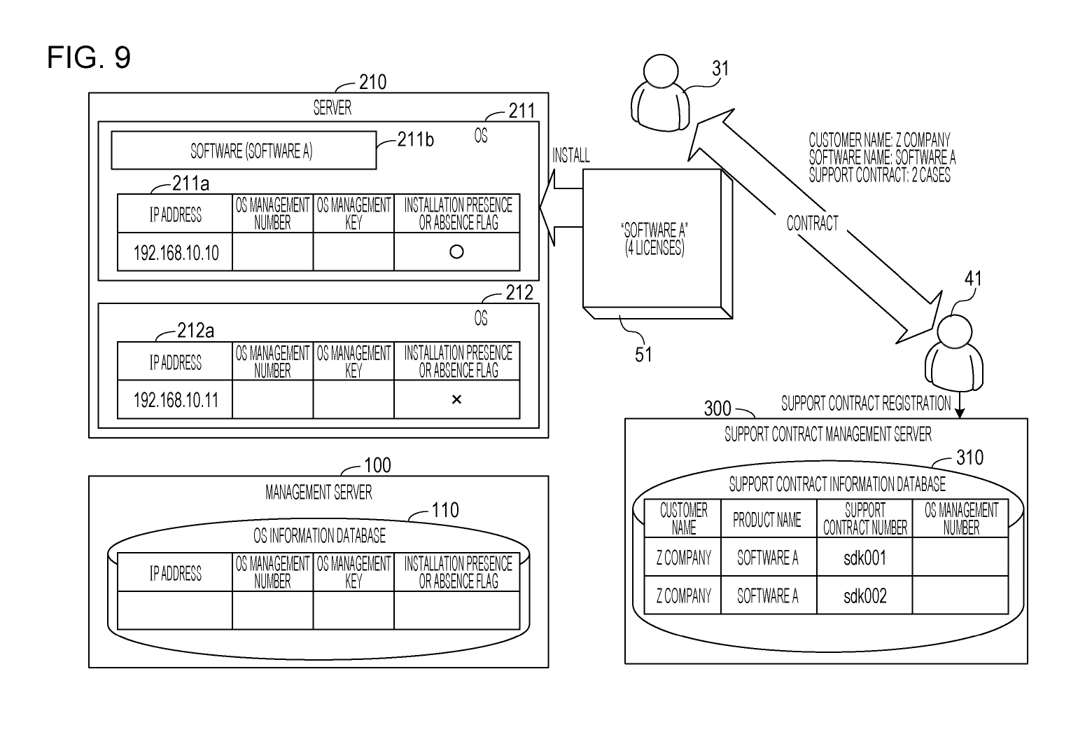

FIG. 9 is a diagram illustrating an example of a state after software installation and support contract. For example, the user 31 of the customer company 30 notifies the support representative 41 of the service provider 40 of the customer name (company Z), the software name (software A), and the number of support contracts (two cases) at the time of purchasing the software. When the support contract is established between the customer company 30 and the service provider 40, the support representative 41 stores information on the concluded support contract in the support contract information database 310 in the support contract management server 300.

In the example of FIG. 9, since the customer company 30 has purchased two support contracts, two records are added to the support contract information database 310. In the two added records, the common customer name and product name are set. In addition, the support contract numbers of the two added records are different values.

After concluding the support contract, the user 31 installs the software using the software package 51. In the example of FIG. 9, the software 211b is installed in the OS 211. When the user 31 installs the software 211b in the OS 211, the installation information of the software 211b is written in the registry 211a of the OS 211. That is, a value indicating installation is set in the installation presence or absence flag.

In addition, as preparation for receiving support based on the support contract, the user 31 registers information on the OS 211 that installs the software 211b in the management server 100.

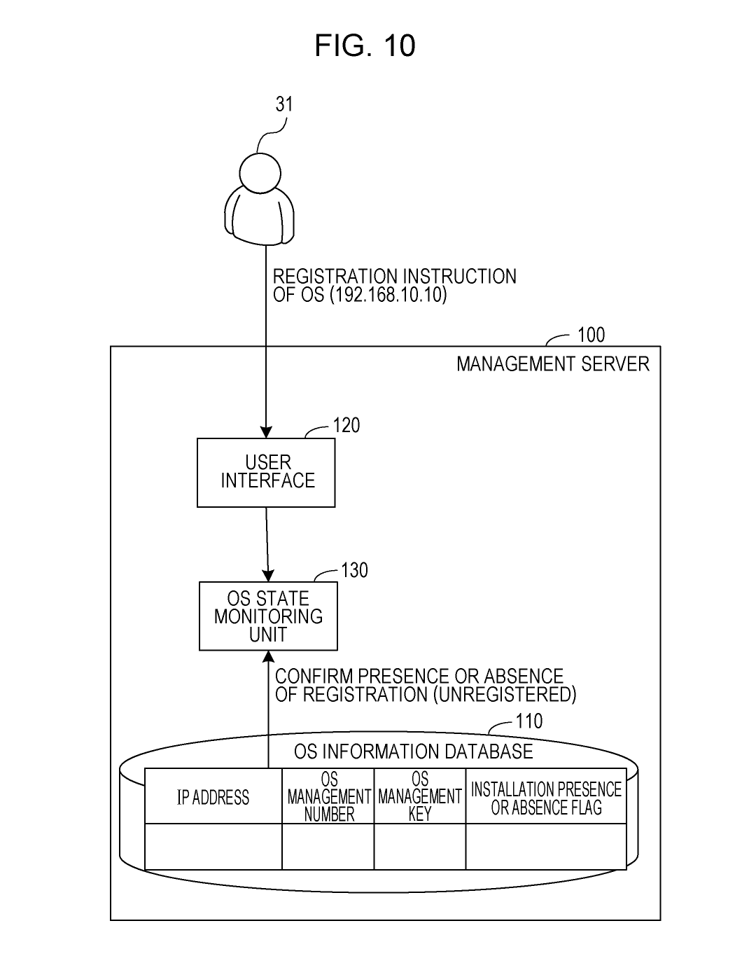

FIG. 10 is a first diagram illustrating an example of a registration status of OS information in a management server. The user 31 performs inputting to instruct registration in the OS information database 110 of the OS 211 in which the software to be supported is installed in the user interface 120. For example, the user 31 inputs the registration instruction including the IP address of the OS 211. The registration instruction is received by the user interface 120 and transferred to the OS state monitoring unit 130.

Firstly, the OS state monitoring unit 130 receiving the registration instruction acquires a record indicating OS information that is already registered from the OS information database 110. At this time, in a case where the record is registered in the OS information database 110, the OS state monitoring unit 130 performs rewriting processing of the OS management key of the acquired record. However, in the example of FIG. 10, since the record of the OS information is not registered, the rewriting processing of the OS management key is not performed.

The OS state monitoring unit 130 confirming that there is no record indicating the OS information in the OS information database 110 performs registration processing of the OS information according to the registration instruction.

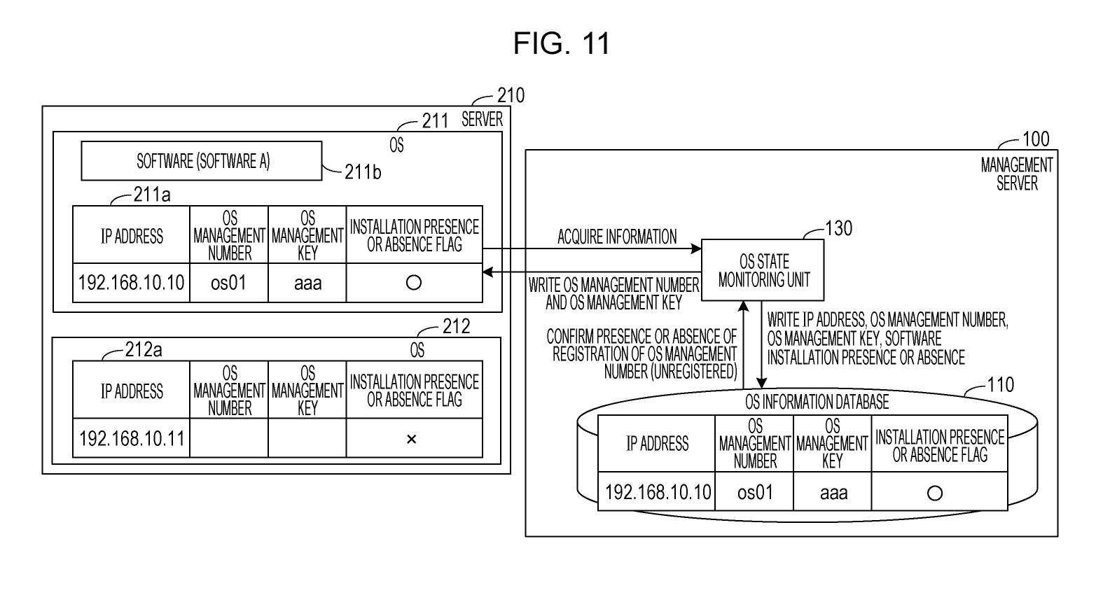

FIG. 11 is a second diagram illustrating an example of the registration status of the OS information in the management server. Firstly, the OS state monitoring unit 130 acquires the various information items of the OS management number, the OS management key, and the installation presence or absence flag from the registry 211a of the OS 211 to be managed. At this stage, the OS management number and the OS management key are not registered in the registry 211a. Therefore, the OS state monitoring unit 130 can acquire only the installation presence or absence flag.

Next, the OS state monitoring unit 130 refers to the OS information database 110 and confirms whether the acquired OS management number is already registered. In the example of FIG. 11, the OS management number is unregistered at the confirmation stage.

In a case where the OS management number is not registered in the OS information database 110, the OS state monitoring unit 130 newly generates an OS management number and OS management key, and writes it in the registry 211a of the OS 211. Furthermore, the OS state monitoring unit 130 registers a new record including information on the software 211b registered in the registry 211a of the OS 211 in the OS information database 110. In the example of FIG. 11, the record in which an IP address “192.168.10.10” of the OS 211, an OS management number “os01”, an OS management key “aaa”, and the installation presence or absence flag “O” are set are registered in the OS information database 110.

In this manner, the OS management number and the OS management key are given to the OS 211 in which the software 211b is installed. The same contents as the information on the software 211b stored in the registry 211a of the OS 211 are registered in the OS information database 110 in the management server 100.

The example of FIG. 11 is processing in a case where the user 31 inputs the registration instruction of the OS 211 in which the software 211b is already installed. However, the user 31 can input the registration instruction relating to the OS of the OS in which installation of the software is not implemented.

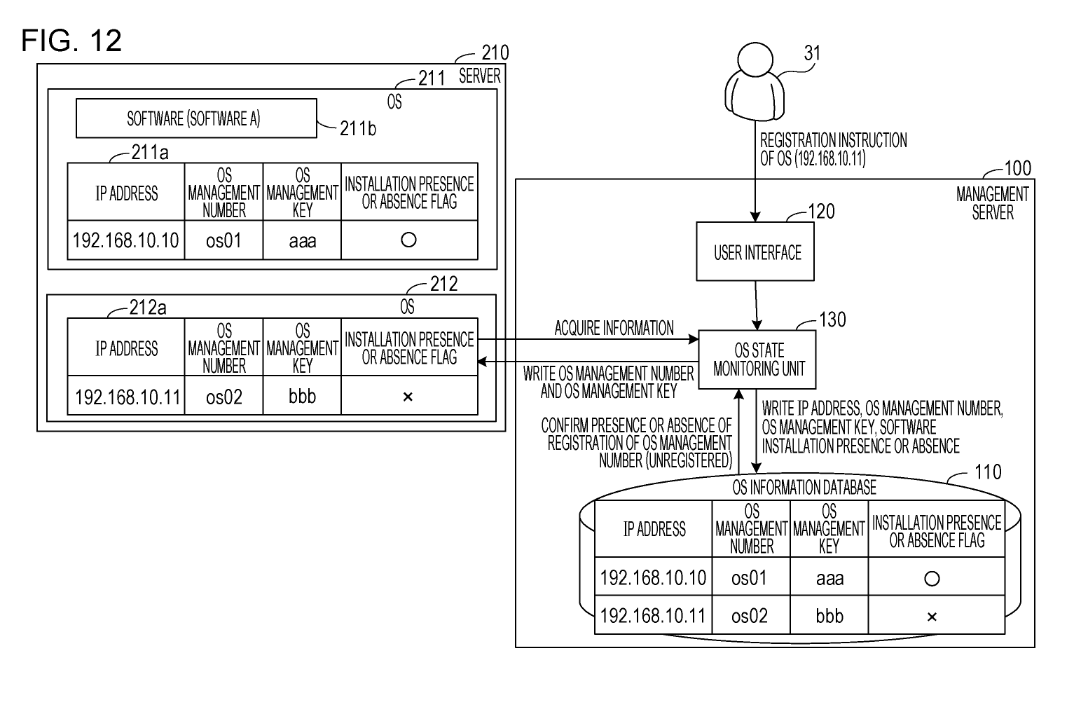

FIG. 12 is a third diagram illustrating an example of the registration status of the OS information in the management server. In the example of FIG. 12, the user 31 inputs the registration instruction relating to the OS 212 in which the software is not installed to the management server 100. The input registration instruction is received by the user interface 120 and transferred to the OS state monitoring unit 130. At this time, as illustrated in FIG. 10, the OS state monitoring unit 130 confirms whether the record is registered in the OS information database 110 and updates the OS management key of the registered record. However, these processes are omitted in FIG. 12.

The OS state monitoring unit 130 first acquires various information items of the OS management number, the OS management key, and the installation presence or absence flag from a registry 212a of the OS 212 to be managed. Next, the OS state monitoring unit 130 refers to the OS information database 110 and confirms whether the acquired OS management number is already registered. In the example of FIG. 12, the OS management number is unregistered at the confirmation stage. Therefore, the OS state monitoring unit 130 newly generates the OS management number and the OS management key, and writes the OS management number and the OS management key in the registry 212a of the OS 212. Furthermore, the OS state monitoring unit 130 registers a new record including information on the software registered in the registry 212a of the OS 212 in the OS information database 110. In the example of FIG. 12, the record in which the IP address “192.168.10.11” of the OS 212, the OS management number “os02”, the OS management key “bbb”, and the installation presence or absence flag “X” are set is registered in the database 110.

In this manner, even for the OS 212 in which software is not installed, the corresponding record can be registered in the OS information database 110 of the management server 100. The user 31 can perform installation of the software in the OS 212 after instructing registration to the management server 100.

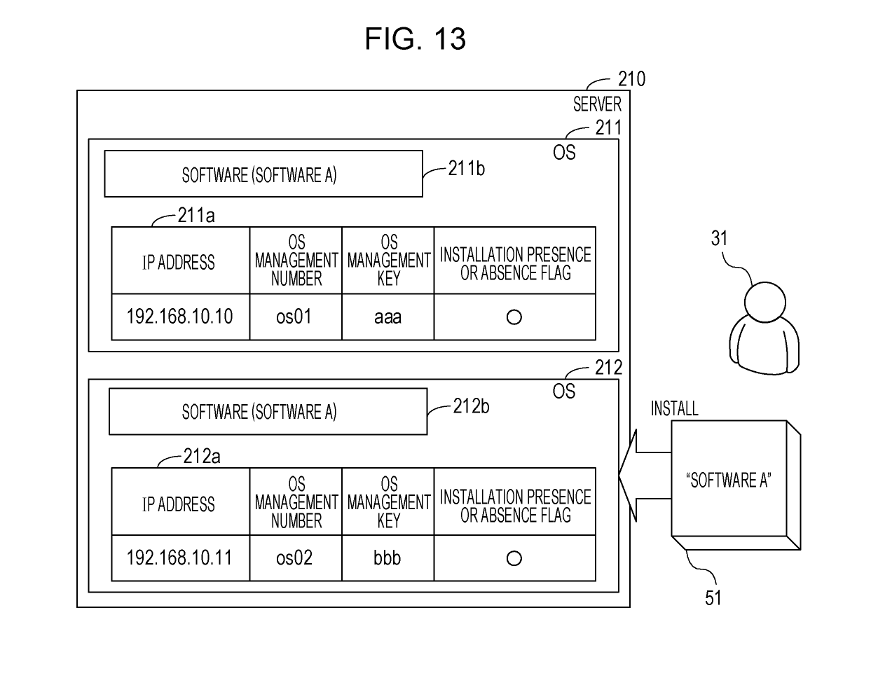

FIG. 13 is a diagram illustrating an example of an installation status of software after registration in the management server. For example, the user 31 installs software 212b to the OS 212 using the software package 51. When the user 31 installs the software 212b in the OS 212, the installation information of the software 212b is written in the registry 212a of the OS 212. That is, a value indicating installation is set in the installation presence or absence flag.

Immediately after installing the software 212b in the OS 212, the information on the software 212b indicated in the registry 212a is not reflected in the OS information database 110 of the management server 100. Therefore, the management server 100 periodically acquires the installation presence or absence flag of the software.

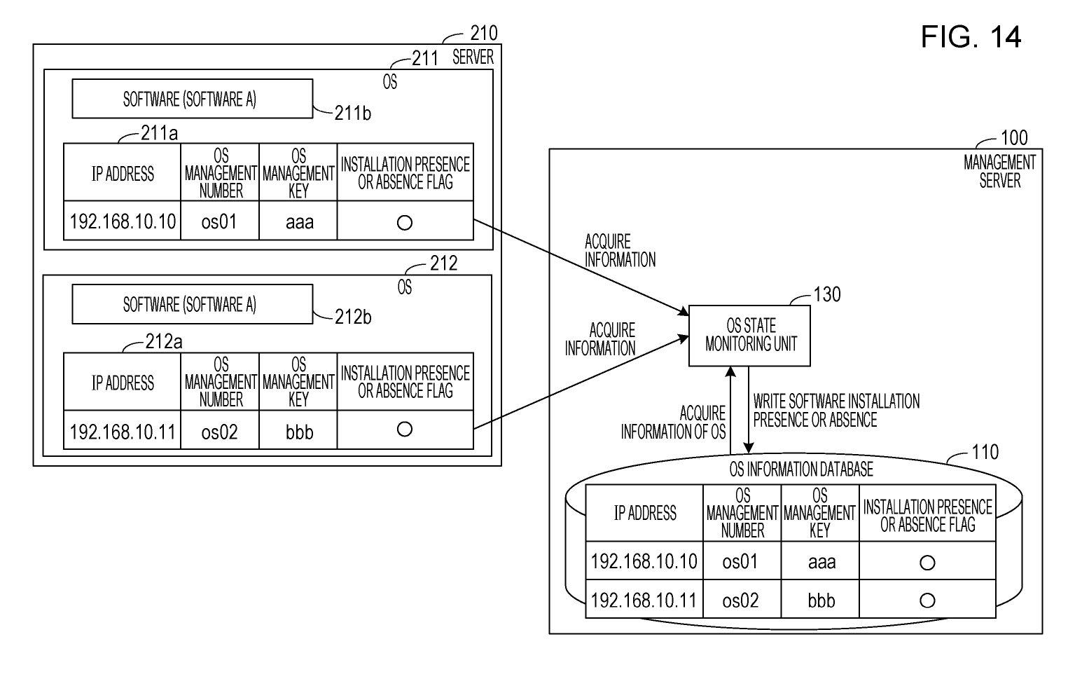

FIG. 14 is a diagram illustrating an example of a status of a periodic acquisition of an installation presence or absence flag. The OS state monitoring unit 130 of the management server 100 performs acquisition processing of the installation presence or absence flag on setting time basis. For example, the OS state monitoring unit 130 acquires the records of the registered OSs 211 and 212 from the OS information database 110. Next, the OS state monitoring unit 130 acquires the installation presence or absence flag from the registries 211a and 212a of the OSs 211 and 212 in which the records are already registered. The OS state monitoring unit 130 writes the installation presence or absence flag obtained from each of the OSs 211 and 212 to the OS information database 110.

In this manner, even in a case where the software is installed in the OS after the OS information is registered in the management server 100, the management server 100 can grasp that the software is installed.

Thereafter, the software is also installed in the two OSs in the server 220, and it is assumed that records indicating the information of these OSs are stored in the OS information database 110. As a result, the software is installed for the OS corresponding to the number of licenses of the software package 51.

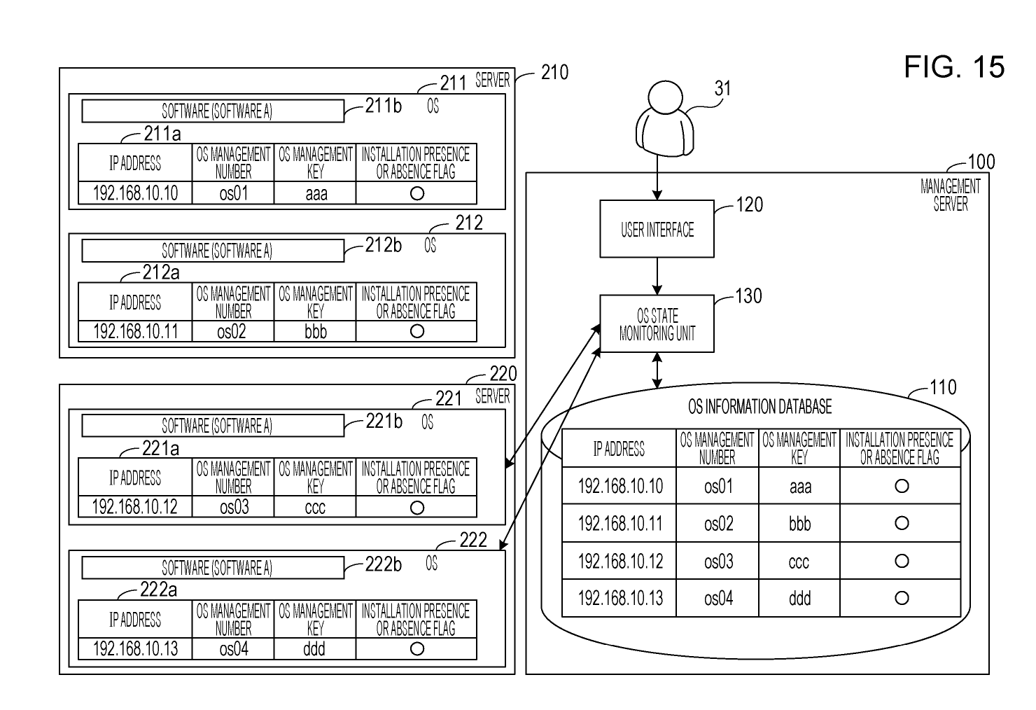

FIG. 15 is a diagram illustrating an example of a state after software installation corresponding to the number of licenses. In the server 220, two OSs 221 and 222 are executed. The software 221b and 222b are installed in each of the OSs 221 and 222. Information on the installed software 221b and 222b is registered in the registries 221a and 222a of the OSs 221 and 222.

In the OS information database 110 of the management server 100, the records corresponding to the two OSs 221 and 222 in the server 220 are registered. In each record, the IP address of the corresponding OS, the OS management number, the OS management key, and the installation presence or absence flag indicating that the software is installed are set.

The OS executed in each of the server 210 and 220 can change the IP address. In the OS in which the IP address is changed, the OS management number is not changed. However, the OS management key is changed.

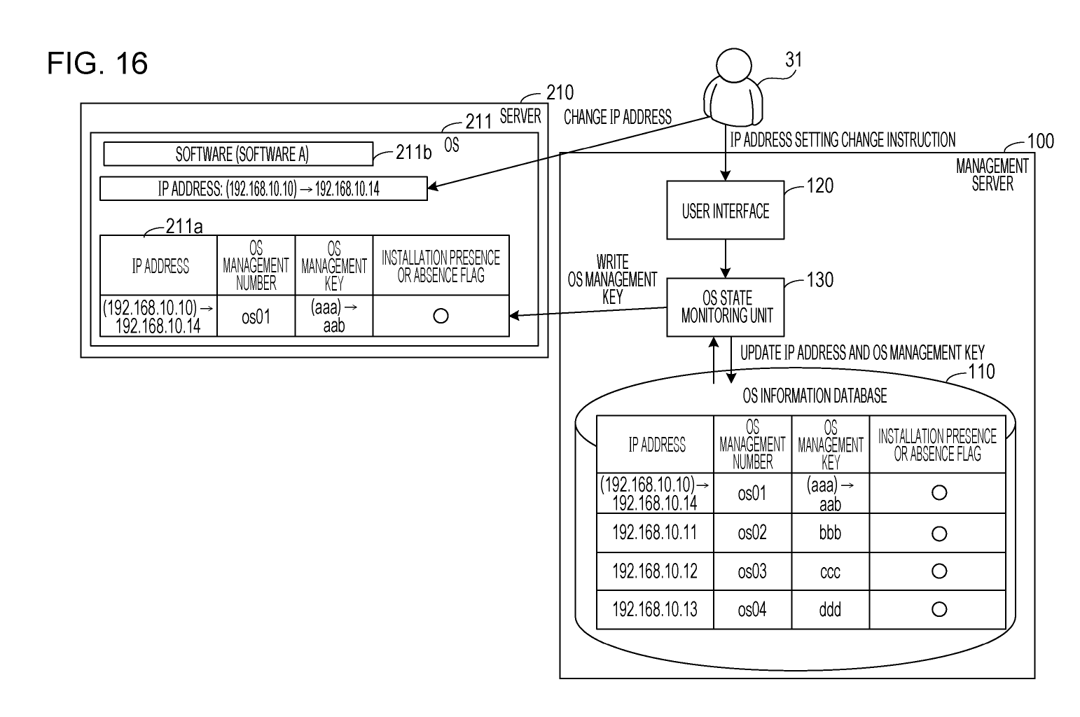

FIG. 16 is a diagram illustrating an example of an IP address change status. In the example of FIG. 16, the user 31 changes the IP address of the OS 211 in the server 210 from “192.168.10.10” to “192.168.10.14”. After changing the IP address of the OS 211, the user 31 instructs the management server 100 to change the IP address of the OS 211. For example, the user 31 inputs the IP address setting change instruction specifying the IP address “192.168.10.10” before the change and the IP address “192.168.10.14” after the change to the management server 100.

In the management server 100, the user interface 120 receives an IP address setting change instruction. The user interface 120 transfers the acquired IP address setting change instruction to the OS state monitoring unit 130. The OS state monitoring unit 130 acquires a record corresponding to the IP address “192.168.10.10” before the change from the OS information database 110. Next, the OS state monitoring unit 130 generates a new OS management key “aab” for the OS 211. Furthermore, the OS state monitoring unit 130 accesses the OS 211 based on the changed IP address, and writes the newly generated OS management key “aab” as the OS management key in the registry 211a in the OS 211.

In addition, the OS state monitoring unit 130 updates the IP address of the acquired record to the changed IP address “192.168.10.14”, updates the OS management key of the record to the newly generated OS management key “aab”. The OS state monitoring unit 130 writes the updated record back to the original location in the OS information database 110.

In this manner, in a case where the IP address of the OS is changed, the IP address of the record corresponding to the OS in the OS information database 110 and the OS management key are updated.

The user 31 performs the work using the software installed in the OS. If the software is used, some bug may occur. There are cases where the cause of the bug is in the software itself, in the OS, or in a server that is operating in the OS, and it is difficult for the user 31 to determine the cause of the bug by itself. In such a case, the user 31 can receive the software support from the service provider 40 based on the support contract.

Next, a support request procedure will be described when a bug occurs during use of one of the installed software.

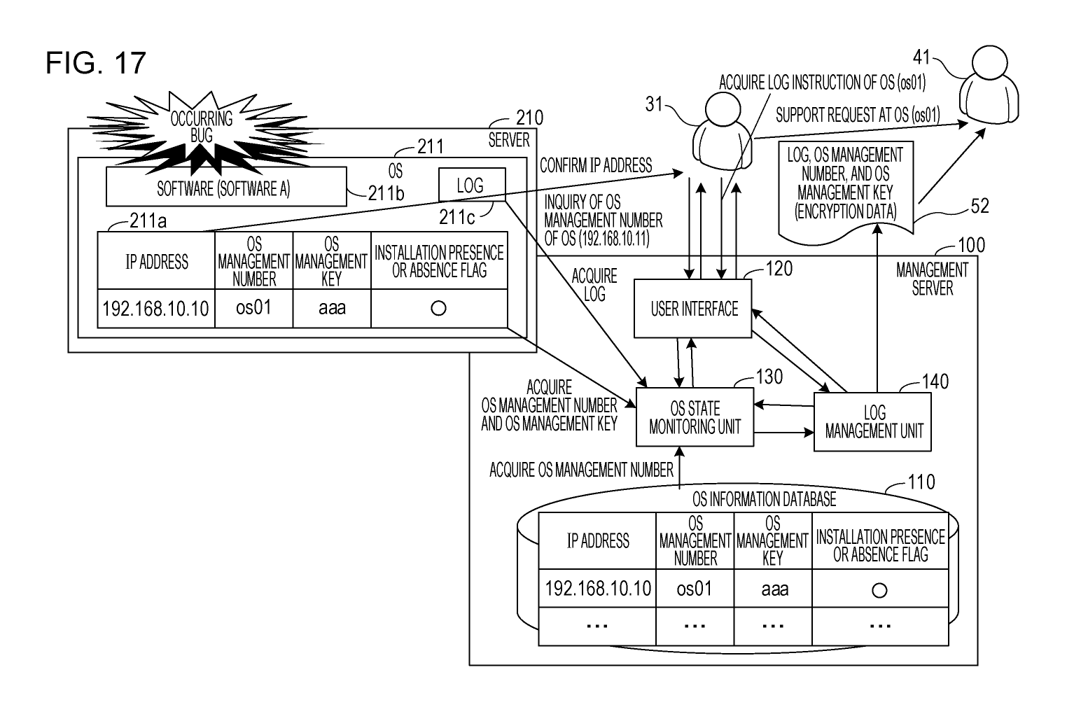

FIG. 17 is a first diagram illustrating an example of a support request. In the example of FIG. 17, in the OS 211 in the server 210, the bug of the software 211b occurs. When the bug occurs in the software 211b, a message (for example, an error message) corresponding to the bug is stored in the log 211c.

When recognizing that the bug occurs in the software 211b, the user 31 confirms the IP address of the OS 211. In the example of FIG. 17, the IP address of the OS 211 is “192.168.10.10”.

The user 31 inputs an inquiry about the OS management number of the OS 211 to the management server 100 by using the IP address of the OS 211 as a key. The inquiry of the OS management number is received by the user interface 120. In response to the inquiry about the acquired OS management number, the user interface 120 transmits an OS management number acquisition request to the OS state monitoring unit 130. The OS state monitoring unit 130 acquires the OS management number “os01” from the record corresponding to the IP address of the OS 211 in the OS information database 110. The OS state monitoring unit 130 transmits the acquired OS management number to the user interface 120. The user interface 120 displays the received OS management number on the monitor 21.

The user 31 confirms the OS management number displayed on the monitor 21 and inputs a log acquisition instruction relating to the software 211b on the OS 211 corresponding to the OS management number to the management server 100. The log acquisition instruction is received by the user interface 120. The user interface 120 transmits the acquired log acquisition instruction to the log management unit 140.

The log management unit 140 acquires the log 211c, the OS management number, and the OS management key of the OS 211 via the OS state monitoring unit 130. For example, the log management unit 140 transmits a log acquisition request of the OS management number “os01” to the OS state monitoring unit 130. In response to the log acquisition request, the OS state monitoring unit 130 acquires the log 211c, the OS management number “os01”, and the OS management key “aaa” from the OS 211 corresponding to the OS management number “os01”. The OS state monitoring unit 130 transfers the information acquired from the OS 211 to the log management unit 140.

The log management unit 140 encrypts the acquired log, OS management number, and OS management key, and generates a file 52 including the encrypted data (encryption data). The log management unit 140 outputs the generated file 52. For example, the log management unit 140 stores the generated file 52 in a predetermined folder (directory) in the storage device 103, and transmits the response to the log acquisition completion to the user interface 120. The user interface 120 displays that storage of the file including the log is completed on the monitor 21.

The user 31 performs a support request to the support representative 41 of the service provider 40. The support request is performed by measures such as telephone, e-mail, and the like. When request for the support, the user 31 informs the support representative 41 of the customer name, the OS management number, and the software name. In addition, the user 31 hands the encrypted file 52 to the support representative 41. For example, the user 31 attaches the file 52 to the support request e-mail using an e-mail function of the management server 100 and transmits the file to the e-mail address of the support representative 41.

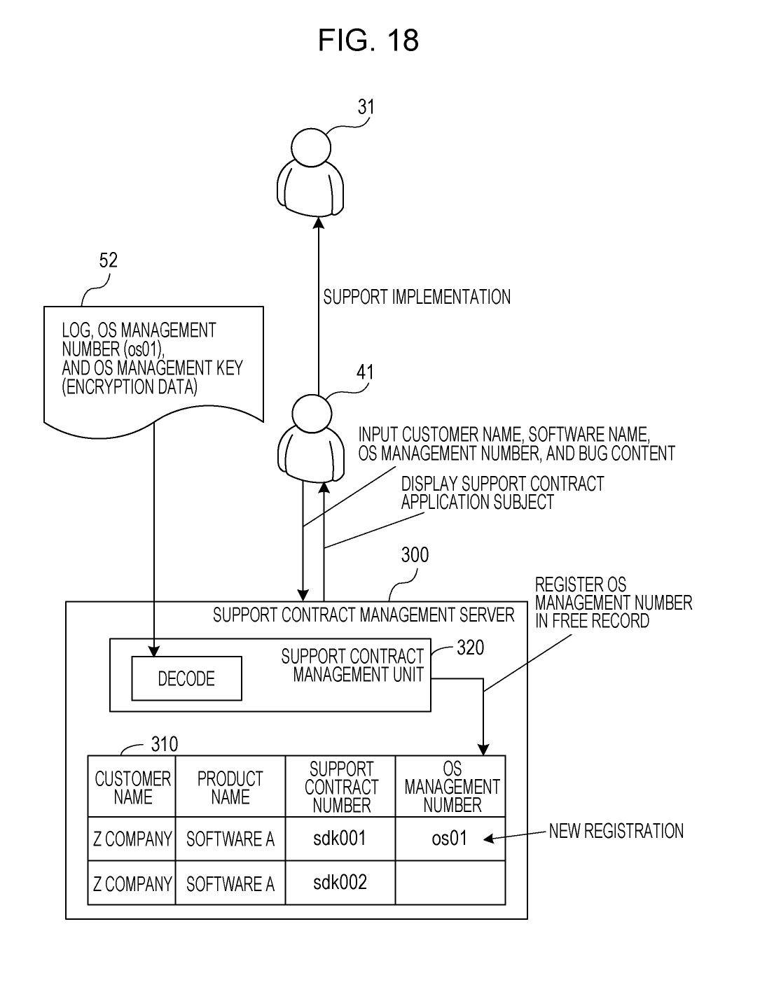

FIG. 18 is a second diagram illustrating an example of the support request. When receiving the support request, the support representative 41 inputs the file 52 received from the user 31 to the support contract management server 300. The input file 52 is decrypted by the support contract management unit 320. For example, the support representative 41 stores the file 52 in the storage device of the support contract management server 300. The support representative 41 inputs the decryption instruction of the file 52 to the support contract management server 300.

The decryption instruction is received by the support contract management unit 320. The support contract management unit 320 decrypts the data in the file 52 and stores a new file including the decrypted data in the storage device.

In addition, the support representative 41 inputs the customer name, the software name, the OS management number, and the bug content notified from the user 31 to the support contract management server 300. In this regard, the support contract management unit 320 refers to the information in the decrypted file, confirms that it is a log of the OS with the OS management number transmitted from the user 31, and that the bug of the contents receiving the support request is received.

Next, the support contract management unit 320 acquires the record indicating the support contract corresponding to the set of the customer name and the software name from the support contract information database 310 with the customer name and the software name as keys. The support contract management unit 320 confirms whether or not there is a record in which the value in a section of the OS management number matches the OS management number transmitted from the user 31 among the records of the acquired support contract. In the example of FIG. 18, the corresponding record does not exist. Therefore, the support contract management unit 320 confirms whether there is a record with the OS management number section empty in the retrieved support contract record. In the example of FIG. 18, there is the record in which the section of the OS management number is empty.

The support contract management unit 320 registers the OS management number entered this time in the section of the OS management number of the record in which the section of the OS management number is empty. In the example of FIG. 18, the OS management number “os01” is set in a head record of the support contract information database 310. As a result, one support contract and the OS management number are associated to each other.

The support contract management unit 320 displays that the bug software is the subject of the support contract. The support representative 41 confirms that the support contract is applicable, and implements the support of the software 211b to the user 31.

According to the processing illustrated in FIG. 18, it is registered in the support contract information database 310 that the software 211b installed in the OS 211 with the OS management number “os01” is the target of the support contract. Thereafter, in a case where the bug occurs in the software 211b, after the support contract is confirmed, support by the support representative 41 is implemented.

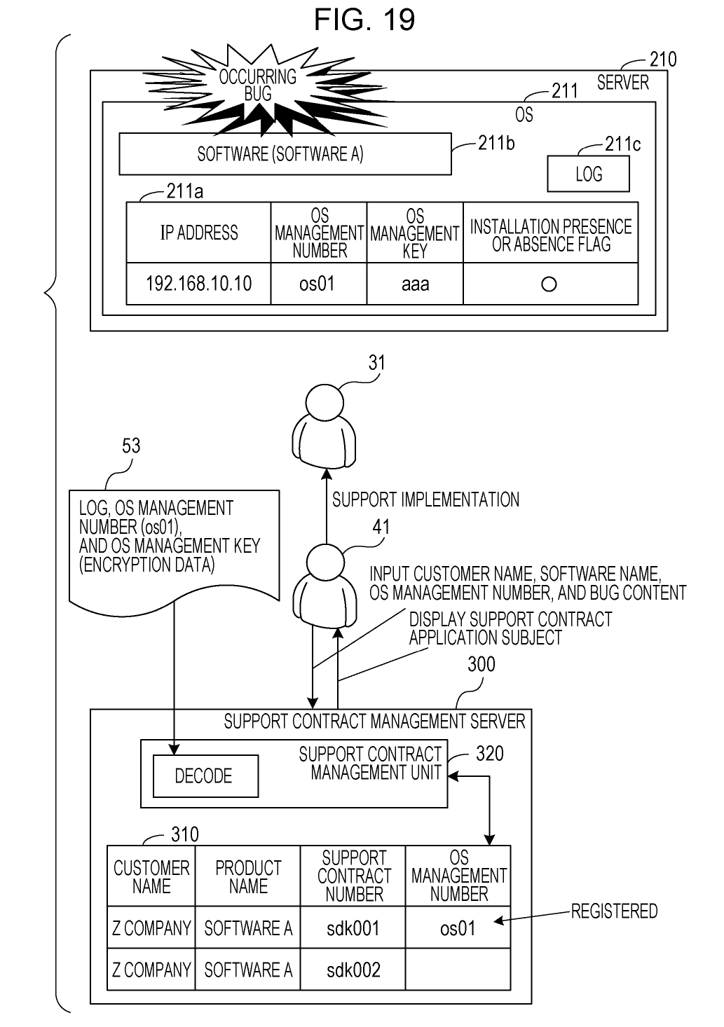

FIG. 19 is a diagram illustrating an example of coping with a case where a bug occurs in software targeted for support contract. When the bug occurs again in the software 211b, the user 31 performs the support request to the support representative 41, informs the customer name, OS management number, software name and hands an encrypted file 53 to the support representative 41.

The support representative 41 inputs the customer name, the OS management number, and the software name to the support contract management server 300, and causes the support contract management unit 320 to decrypt the file 53. The support contract management unit 320 confirms that it is the log of the OS of the OS management number transmitted from the user 31, and that the bug of the content transmitted from the user 31 occurs based on the decrypted data. In addition, the support contract management unit 320 acquires the record of the support contract corresponding to the key from the support contract information database 310 using the customer name and the software name as keys. The support contract management unit 320 confirms whether there is the record where the section of the OS management number matches the OS management number transmitted from the user among the records of the acquired support contract. In the example of FIG. 19, the corresponding record exists. The support contract management unit 320 displays that the bug software is the subject of the support contract. The support representative 41 confirms that the support contract is applicable, and implements the support of the software 211b to the user 31.

In this manner, in a case where the bug occurs in the software 211b which becomes already a target of the support contract, support is implemented based on the support contract.

Next, a case where the bug occurs in the software different from the software 211b to be a target of the support contract will be described.

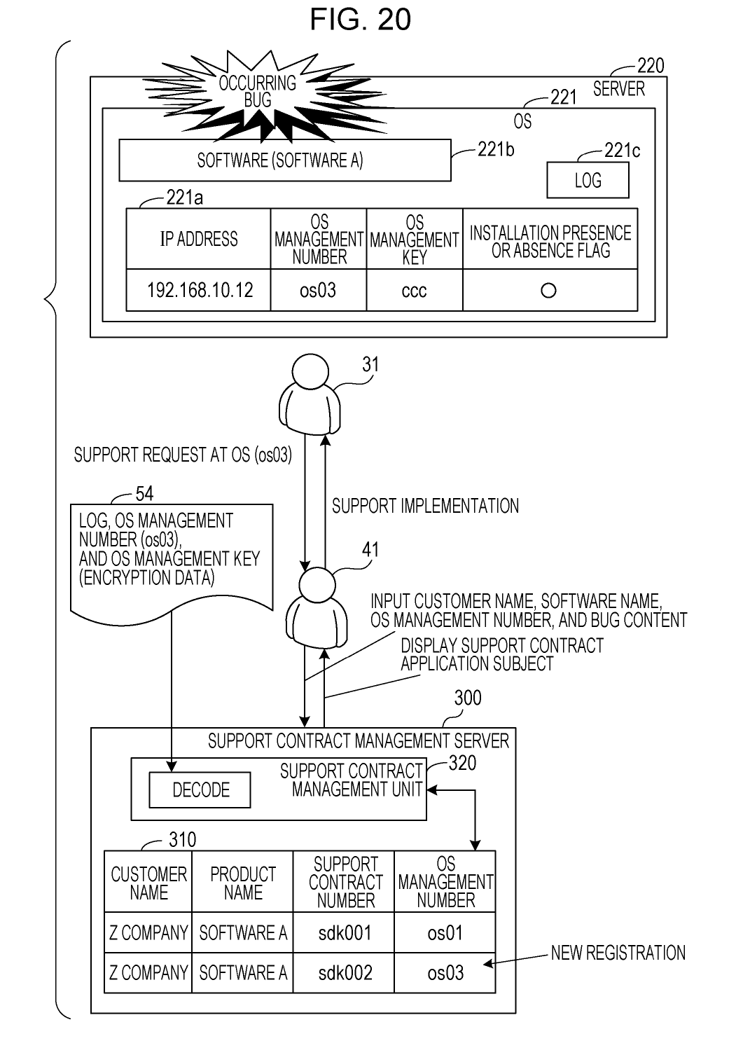

FIG. 20 is a diagram illustrating an example of coping with a case where the bug occurs in the software different from a support contract target. When the bug occurs in the software 221b installed in the OS 221 in the server 220, the user 31 performs the support request to transmit the customer name, the OS management number, and the software name to the support representative 41. The user 31 hands the encrypted file 54 to the support representative 41.

The support representative 41 inputs the customer name, the OS management number, and the software name to the support contract management server 300, and causes the support contract management unit 320 to decrypt the file 54. The support contract management unit 320 confirms that it is the log of the OS of the OS management number transmitted from the user 31, and that the bug of the content transmitted from the user 31 occurs based on the decrypted data. Next, the support contract management unit 320 acquires the record of the support contract corresponding to the key from the support contract information database 310 using the customer name and the software name as keys. The support contract management unit 320 confirms whether there is the record where the section of the OS management number matches the OS management number transmitted from the user among the records of the acquired support contract. In the example of FIG. 20, the corresponding record exists. Therefore, the support contract management unit 320 confirms whether there is a record with the OS management number section empty in the retrieved support contract record. In the example of FIG. 20, there is the record in which the section of the OS management number is empty.

The support contract management unit 320 registers the OS management number input this time in the section of the OS management number of the record in which the section of the OS management number is empty. The support contract management unit 320 displays that the bug software is the subject of the support contract. The support representative 41 confirms that the support contract is applicable, and implements the support of the software 221b to the user 31.

Since the customer company 30 is only concluded support contracts for two software, the two software items that can be subject to the support contract are specified by the processing of FIG. 20. Here, a case where the bug occurs with more software than the target number of the support contracts.

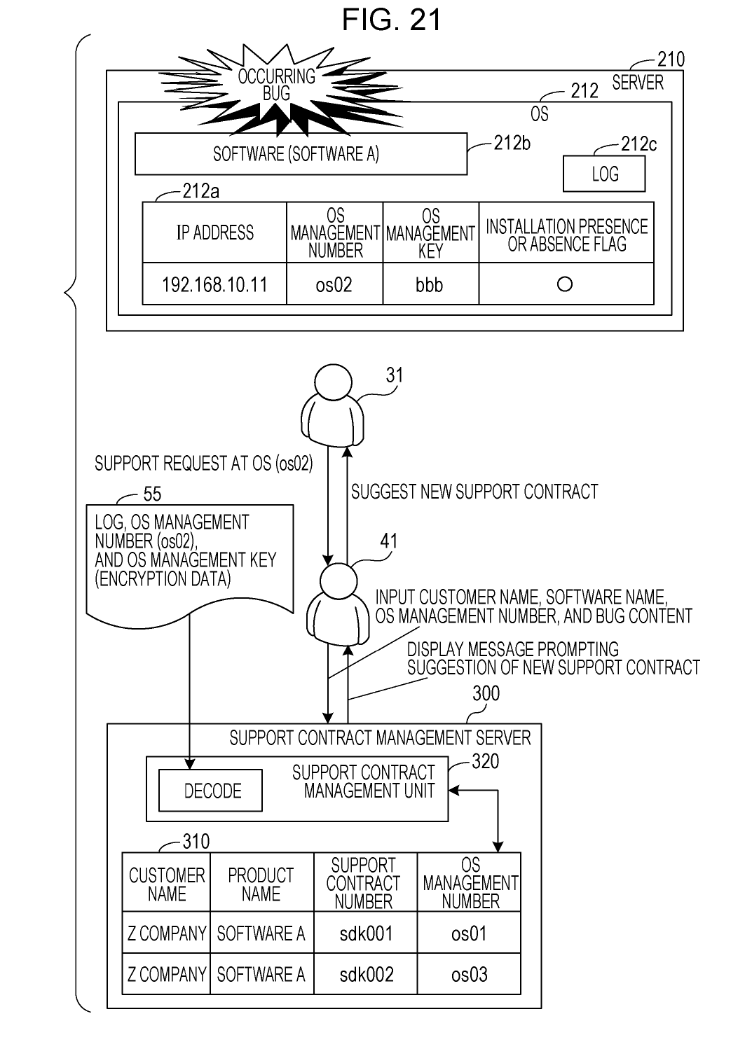

FIG. 21 is a diagram illustrating an example of coping with a case where the bug occurs in the software in which the number of the support contracts is equal to or more than the number of targets of the support contract. When the bug occurs in the software 212b installed in the OS 212 in the server 210, the user 31 performs the support request to transmit the customer name, the OS management number, and the software name to the support representative 41. The user 31 hands the encrypted file 55 to the support representative 41.

The support representative 41 inputs the customer name, the OS management number, and the software name to the support contract management server 300, and causes the support contract management unit 320 to decrypt the file 55. The support contract management unit 320 confirms that it is the log of the OS of the OS management number transmitted from the user 31, and that the bug of the content transmitted from the user 31 occurs based on the decrypted data. Next, the support contract management unit 320 acquires the record of the support contract corresponding to the key from the support contract information database 310 using the customer name and the software name as keys. The support contract management unit 320 confirms whether there is the record where the section of the OS management number matches the OS management number transmitted from the user among the records of the acquired support contract. In the example of FIG. 21, the corresponding record exists. Therefore, the support contract management unit 320 confirms whether there is a record with the OS management number section empty in the retrieved support contract record. In the example of FIG. 21, there is the record in which the section of the OS management number is empty. In this case, the support contract management unit 320 displays a message prompting suggestion of a new support contract. The support representative 41 confirms the message and suggests conclude a new support contract to the user 31.

In this manner, when the bug occurs with software equal to or more than the number of targets of the support contract, the user 31 may not receive support for software that exceeds the number of support contracts. In this case, there is a possibility that the user 31 may misrepresent the OS management number of the OS in which the software where the bug occurs is installed, in order to receive support for software that exceeds the number of support contracts. Next, copying in a case where the user gives the false OS management number will be described.

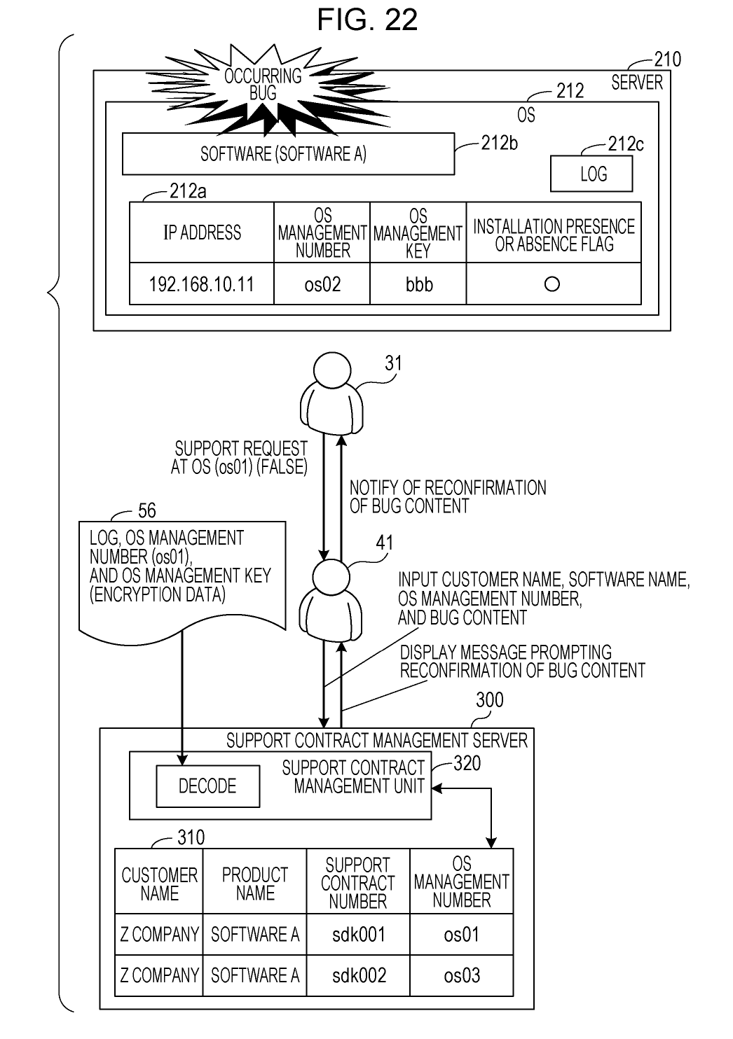

FIG. 22 is a diagram illustrating an example of coping with a case where a false OS management number is transmitted and support is received. The example in FIG. 22 is a case where the user 31 gives a false notification that there is the bug in the software 211b that is already subject to the support contract, even though the bug occurs in the software 212b installed in the OS 212 in the server 210. The user 31 gives the support request to the support representative 41, and informs the customer name, the false OS management number (os01), and the software name. The user 31 hands an encrypted file 56 to the support representative 41. The file 56 includes the log 211c of the software 211b in which the bug does not occur.

The support representative 41 inputs the customer name, the OS management number, and the software name to the support contract management server 300, and causes the support contract management unit 320 to decrypt the file 56. The support contract management unit 320 confirms that it is the OS log of the OS management number (os01) transmitted from the user 31. However, in the example of FIG. 22, evidence of the bug is not found in the log. Therefore, the support contract management unit 320 may not confirm that the bug of the content transmitted from the user 31 occurs. Therefore, the support contract management unit 320 displays a message prompting reconfirmation of bug content. The support representative 41 confirms the message and makes a contact to the user 31 to request reconfirmation of the bug content.

In this manner, even if the user 31 transmits the false OS management number, it is possible to avoid supporting the software that exceeds the number of support contracts.

This is a basic management contract management method.

By managing the support contract in the above manner, even in a case where the software is installed on the virtual machine, it is possible to specify the entities and associate the entities with the support contract. That is, when the user 31 makes an inquiry to the support representative 41, the support representative 41 can correctly determine whether the inquiry content of the user is correct and can make appropriate correspondence.

Copying Procedure in a case where Virtual Machine including an OS is copied

Next, a coping procedure in the case where the virtual machine including an OS is copied will be described.

The virtual machine is a pseudo computer system operating on the computer, and it is possible to perform copying. In the case of copying, the virtual machine including an OS is copied and information specifying the individual of the OS is also copied. In the procedure of providing the support service described above, the OS management number is assigned to each OS. However, in a case where the virtual machine is copied, it is possible to recognize a plurality of OSs having the same OS management number from the management server 100. As a result, it is difficult to connect the OS management number and the support contract on the one-to-one basis.

In order to cope with such copying of the virtual machine, in the second embodiment, the OS management key is associated with each OS separately from the OS management number. The management server 100 updates the OS management key periodically or each time a predetermined operation is performed. That is, the management server 100 generates a new OS management key as appropriate, and overwrites the OS management key in the registry of the OS and the OS information database 110 in the management server 100. As a result, even if the OS is copied and branched into a plurality of pieces, the management server can recognize the OS as different OSs by referencing the OS management keys and reassign another OS management number to each. As a result, even in a case where the virtual machine is copied, support for multiple software with one support contract is suppressed.

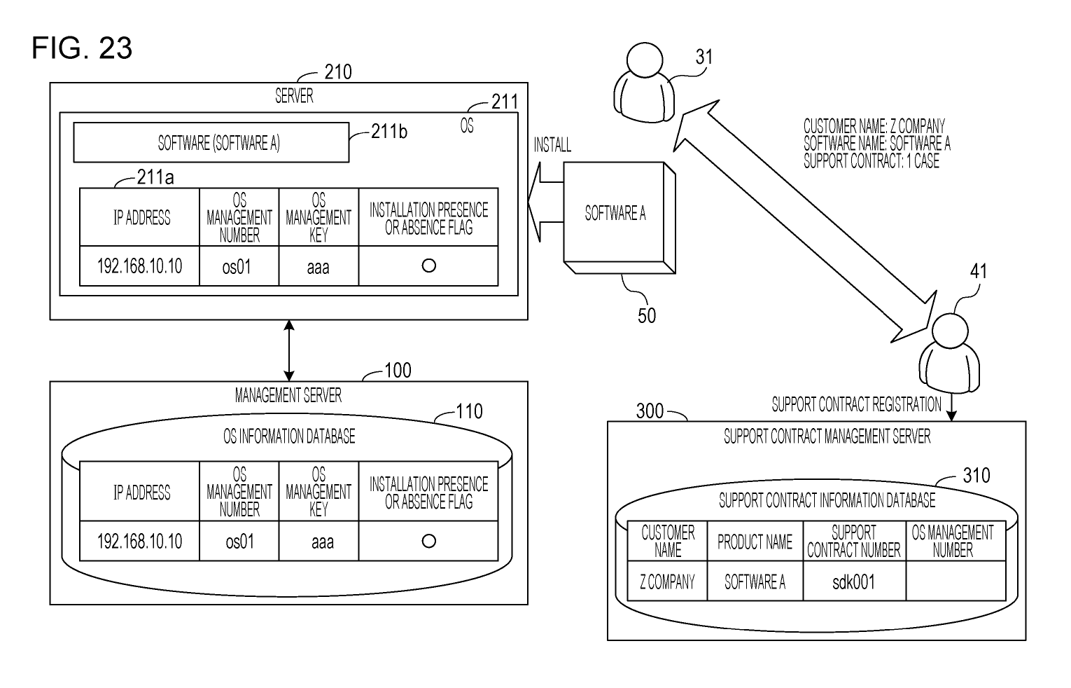

FIG. 23 is a diagram illustrating an example of an operation state before copying a virtual machine. In the example of FIG. 23, it is assumed that the software 211b to be managed is installed in the OS 211 in the server 210, and the software to be managed is not installed in the other OS. In addition, registration of the OS information on the OS 211 is already completed in the management server 100. Furthermore, the support contract for one software is concluded between the customer company 30 and the service provider 40. The information on the support contract is registered in the support contract information database 310 of the support contract management server 300 by the support representative 41.

The case where the virtual machine including an OS is copied in such a state can be considered.

FIG. 24 is a diagram illustrating an example of a state after copying the virtual machine. In the example of FIG. 24, the copy of the virtual machine in the server 210 executing the OS 211 is generated in the server 220. As a result, in the server 220, an OS 223 having the same contents as the OS 211 is executed. That is, the software 223b is the same as the software 211b installed in the OS 211 is installed in the OS 223. In a case where the log 211c of the software 211b is included in the OS 211, the log 223c having the same contents as that of the log 211c is also included in the copy destination OS 223.

Furthermore, immediately after copying, the same information as that of the registry 211a of the OS 211 is set in a registry 223a of the OS 223. If the IP addresses are the same, the two OSs 211 and 223 may not connect to the same network at the same time. Therefore, the IP address of one OS (in the example of FIG. 24, the OS 223 of the copy destination) is changed.

In this manner, as a result of copying the virtual machine, the OS 223 having the OS management number and OS control key same as the OS 211 executed in the copy source virtual machine is generated. In this state, it becomes difficult to specify the support target of software. Therefore, the management server 100 periodically updates the OS management key.

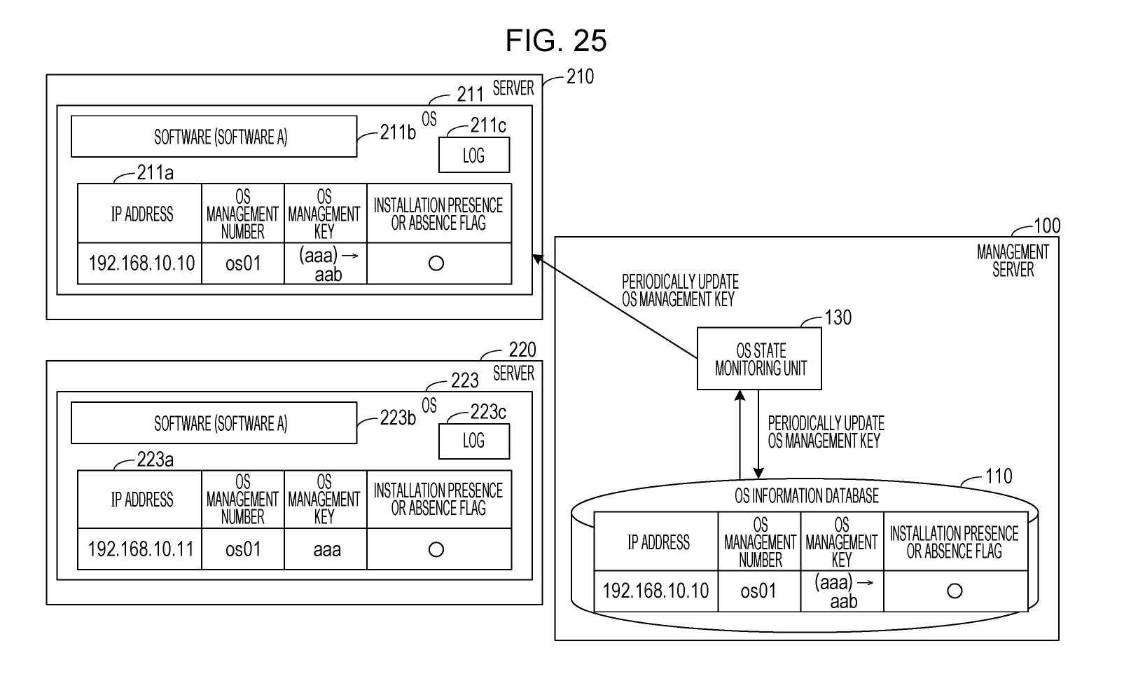

FIG. 25 is a diagram illustrating an example of periodic update status of an OS management key. The OS state monitoring unit 130 periodically performs the following processing at the set time intervals.

First, the OS state monitoring unit 130 acquires the record indicating information of OSs that are already registered from the OS information database 110. Next, the OS state monitoring unit 130 writes the new OS management key in the registry 211a of the OS 211 corresponding to the IP address indicated in the acquired record. In the example of FIG. 25, the OS management key is updated from “aaa” to “aab”. Furthermore, the OS state monitoring unit 130 writes the OS management key newly set in the OS 211 in the section of the OS management key of the corresponding record in the OS information database 110.

As described above, in the second embodiment, the OS management key of the OS recognized by the management server 100 is periodically updated based on the OS information registered in the OS information database 110. Accordingly, the virtual machine is copied, and the copy source OS and the copy destination OS can be distinguished based on the OS management key.

The update of the OS management key is also performed, for example, when the new OS information is registered in the management server 100.

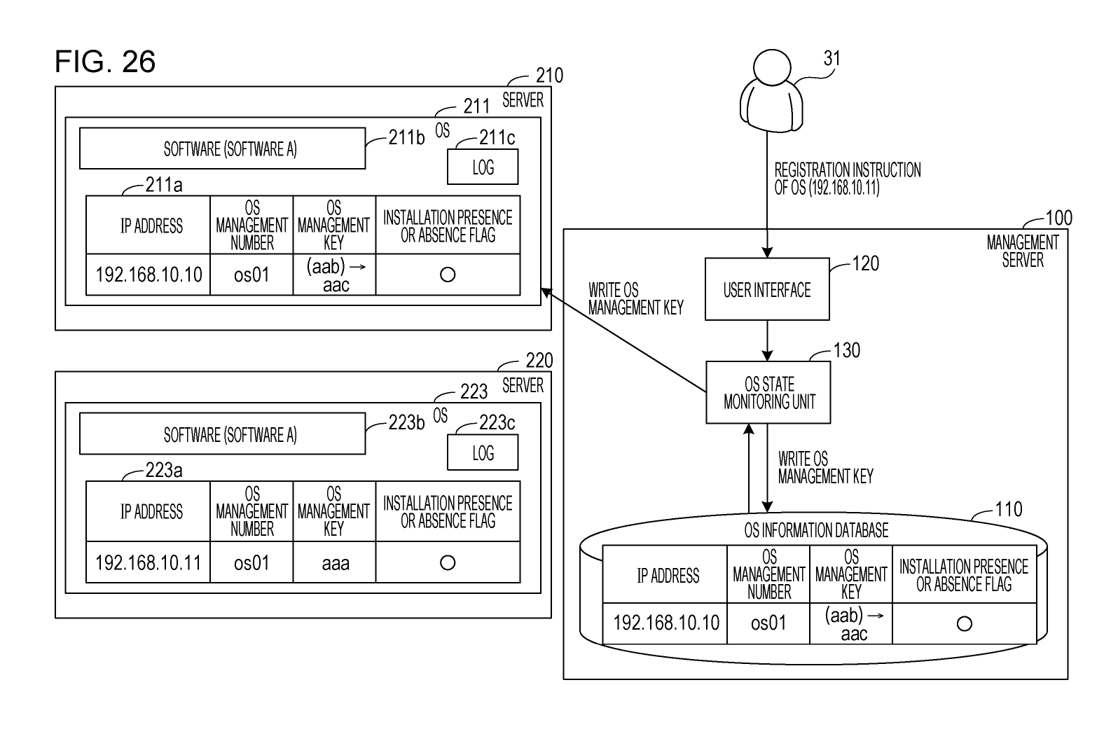

FIG. 26 is a first diagram illustrating an example of a registration status of other OS information in a case where the OS information is already registered. The user 31 inputs the registration instruction of the OS 223 in which the software 223b to be managed is installed in the user interface 120. The registration instruction includes the IP address of the OS 223. The input registration instruction is received by the user interface 120 and transferred to the OS state monitoring unit 130.

Firstly, the OS state monitoring unit 130 receiving the registration instruction acquires a record indicating OS information that is already registered from the OS information database 110. The OS state monitoring unit 130 writes the new OS management key in the registry 211a of the OS 211 corresponding to the IP address indicated in the acquired record. In the example of FIG. 26, the OS management key is updated from “aab” to “aac”. Furthermore, the OS state monitoring unit 130 writes the OS management key newly set in the OS 211 in the corresponding section of the OS management key in the OS information database 110.

Thereafter, registration processing of the OS information in accordance with the registration instruction is performed.

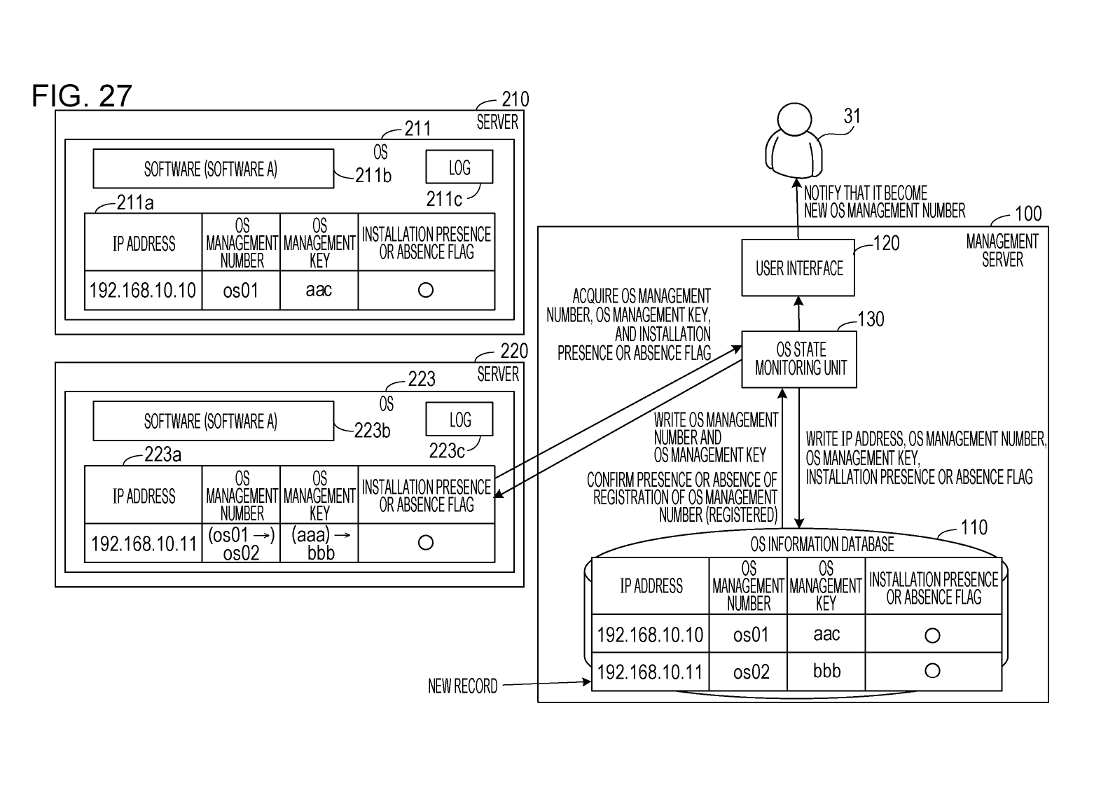

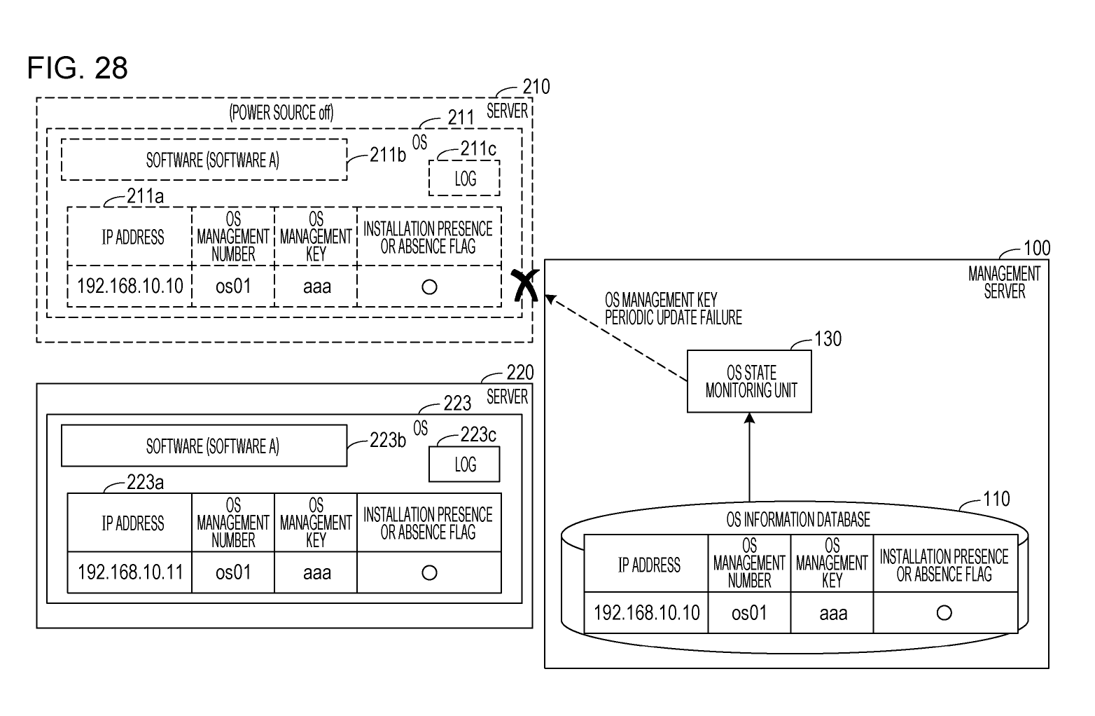

FIG. 27 is a second diagram illustrating an example of the registration status of other OS information in a case where the OS information is already registered. The OS state monitoring unit 130 first acquires various information items of the OS management number, the OS management key, and the installation presence or absence flag from a registry 223a of the OS 223 to be managed. At this stage, the information in the registry 223a illustrated in FIG. 26 is acquired. Next, the OS state monitoring unit 130 refers to the OS information database 110 and confirms whether the acquired OS management number is already registered. In the example of FIG. 27, the OS management number is unregistered at the confirmation stage.

In a case where the OS management number is registered in the OS information database 110, the OS state monitoring unit 130 collates whether the OS management key in the registry 223a matches the OS management key included in the record registered in the OS information database 110. In the example of FIG. 27, the OS management keys do not match to each other. In this case, the OS state monitoring unit 130 notifies the user 31 that the OS management key become a new OS management number via the user interface 120.

The OS state monitoring unit 130 newly generates the OS management number and the OS management key, and writes the newly generated OS management number and the OS management key in the registry 223a of the OS 223. Furthermore, the OS state monitoring unit 130 registers a new record including information on the software 223b registered in the registry 223a of the OS 223 in the OS information database 110. In the example of FIG. 27, the record in which the IP address “192.168.10.11” of the OS 223, the OS management number “os02”, the OS management key “bbb”, and the installation presence or absence flag “0” are set is registered in the OS information database 110.

In this manner, in a case where the OS information registration instruction is input to the management server 100, the OS management key of the OS indicated by the already registered OS information is updated.

In the processing illustrated in FIG. 27, the OS management number of the copy destination OS is changed to the newly generated value. However, the OS management number of the copy source OS is not changed. However, depending on an operation aspect, on the contrary, the OS management number of the copy source OS is changed to the newly generated value, and the OS management number of the copy destination OS may not be changed in some cases. As a case where the OS management number of the copy source OS is changed, for example, after the virtual machine is copied, the power source of the server having the copy source virtual machine may be turned off.

Hereinafter, a case where the power source of the server having the copy source OS is cut off is assumed before the OS management key is updated after the copy of the virtual machine as illustrated in FIG. 24, and the OS management number of the copy source OS will be described.

FIG. 28 is a diagram illustrating an example of the periodic update status of the OS management key after shutting off a power source of a server having a copy source OS. First, the OS state monitoring unit 130 acquires a record indicating information of the OSs that are already registered from the OS information database 110. Next, the OS state monitoring unit 130 tries to write a new OS management key to the registry 211a of the OS 211 corresponding to the IP address indicated in the acquired record. However, since the power source of the server 210 is cut off, the OS state monitoring unit 130 may not access the registry 211a of the OS 211. Therefore, the writing of the OS management key fails, the OS management key is not updated, and the periodical update processing of the OS management key ends.

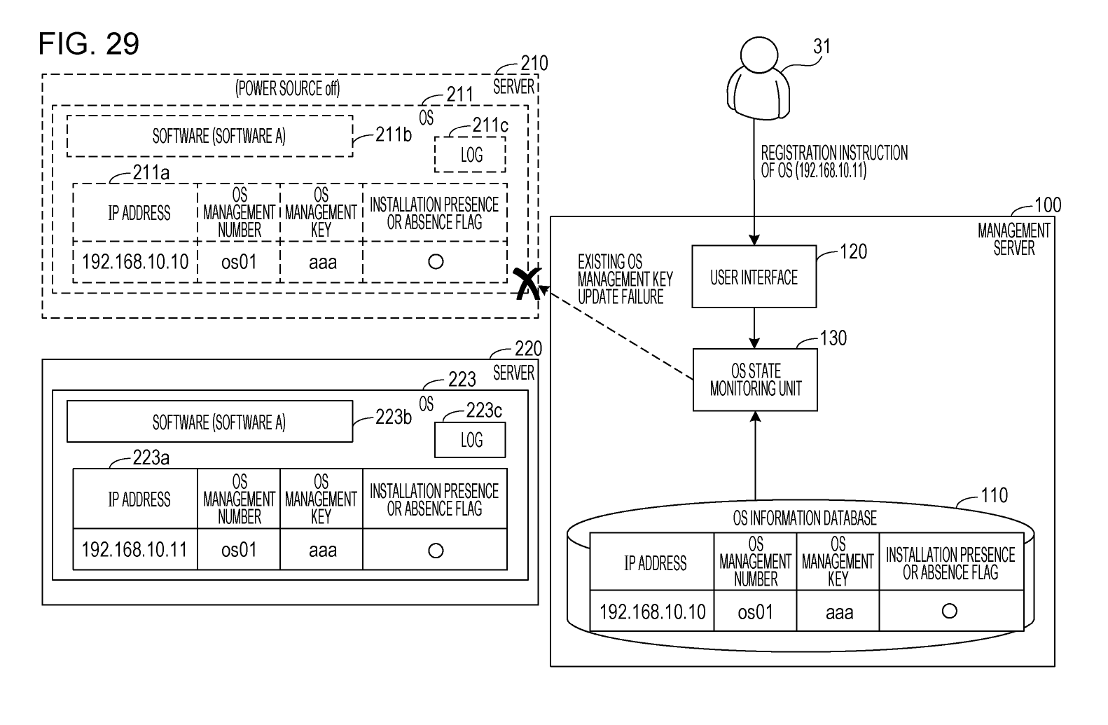

FIG. 29 is a first diagram illustrating an example of an update status of the OS management key accompanying the registration of the OS information after shutting off the power source of the server having the copy source OS. The user 31 inputs the registration instruction of the OS 223 in which the software 223b to be managed is installed in the user interface 120. The registration instruction includes the IP address of the OS 223. The input registration instruction is received by the user interface 120 and transferred to the OS state monitoring unit 130.

Firstly, the OS state monitoring unit 130 receiving the registration instruction acquires a record indicating OS information that is already registered from the OS information database 110. The OS state monitoring unit 130 tries to write a new OS management key to the registry 211a of the OS 211 corresponding to the IP address indicated in the acquired record. However, since the power source of the server 210 is cut off, the OS state monitoring unit 130 may not access the registry 211a of the OS 211. Therefore, the writing of the OS management key fails, the OS management key is not updated, and the registration processing of the OS information in accordance with the registration instruction is performed.

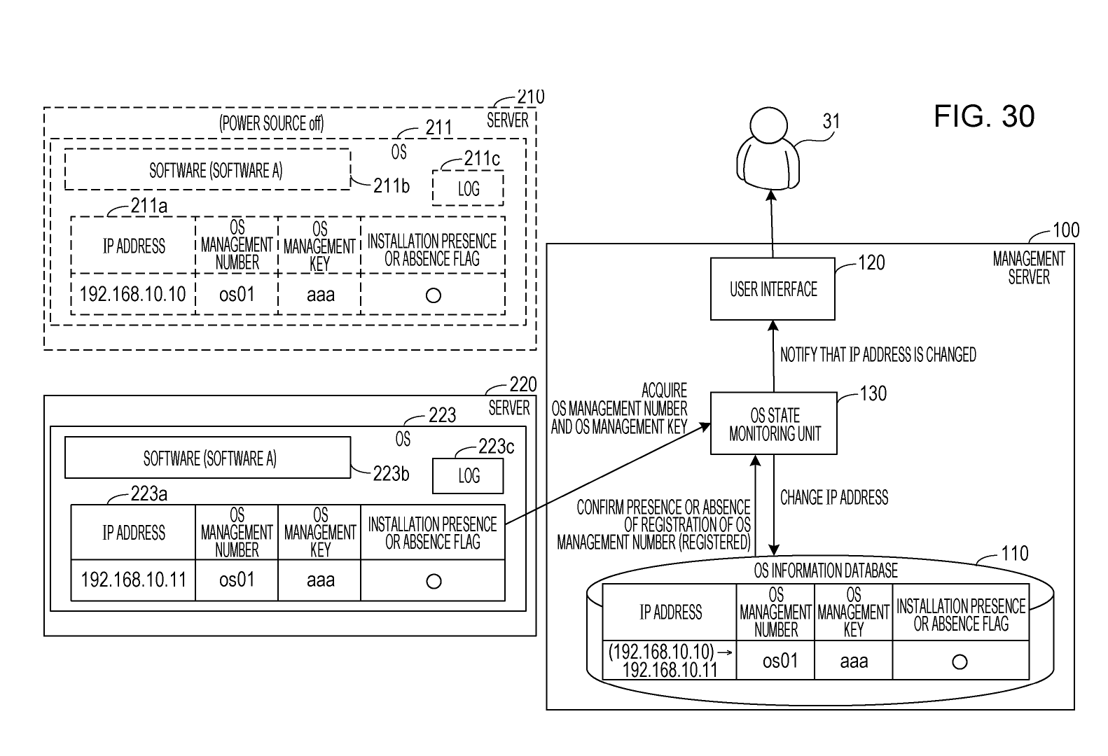

FIG. 30 is a second diagram illustrating an example of the update status of the OS management key accompanying the registration of the OS information after shutting off the power source of the server having the copy source OS. Firstly, the OS state monitoring unit 130 acquires the various information items of the OS management number, the OS management key, and the installation presence or absence flag from the registry 223a of the OS 223 to be managed. Next, the OS state monitoring unit 130 refers to the OS information database 110 and confirms whether the acquired OS management number is already registered. In the example of FIG. 30, the OS management number is unregistered at the confirmation stage.

In a case where the acquired OS management number is registered in the OS information database 110, the OS state monitoring unit 130 determines whether the OS management key of the record including the OS management number matches the OS management key acquired from the OS 223. In the example of FIG. 30, the OS management keys match to each other. In a case where the OS management keys match to each other, the OS state monitoring unit 130 determines that the instructed OS information is already registered, and does not perform a new registration.

However, the IP address “192.168.10.11” of the OS 223 and the IP address “192.168.10.10” set in the record indicating the information of the OS 223 registered in the OS information database 110 are different from each other. Therefore, the OS state monitoring unit 130 changes the IP address of the record to “192.168.10.11”. The OS state monitoring unit 130 notifies the user interface 120 that the registered IP address is changed. The user interface 120 displays that the registered IP address is changed on the monitor 21.

Thereafter, the management server 100 recognizes that the OS corresponding to the OS management key “aaa” is the copy destination OS 223. Thereafter, it is assumed that the OS management key is periodically updated while the power source of the server 210 is cut off.

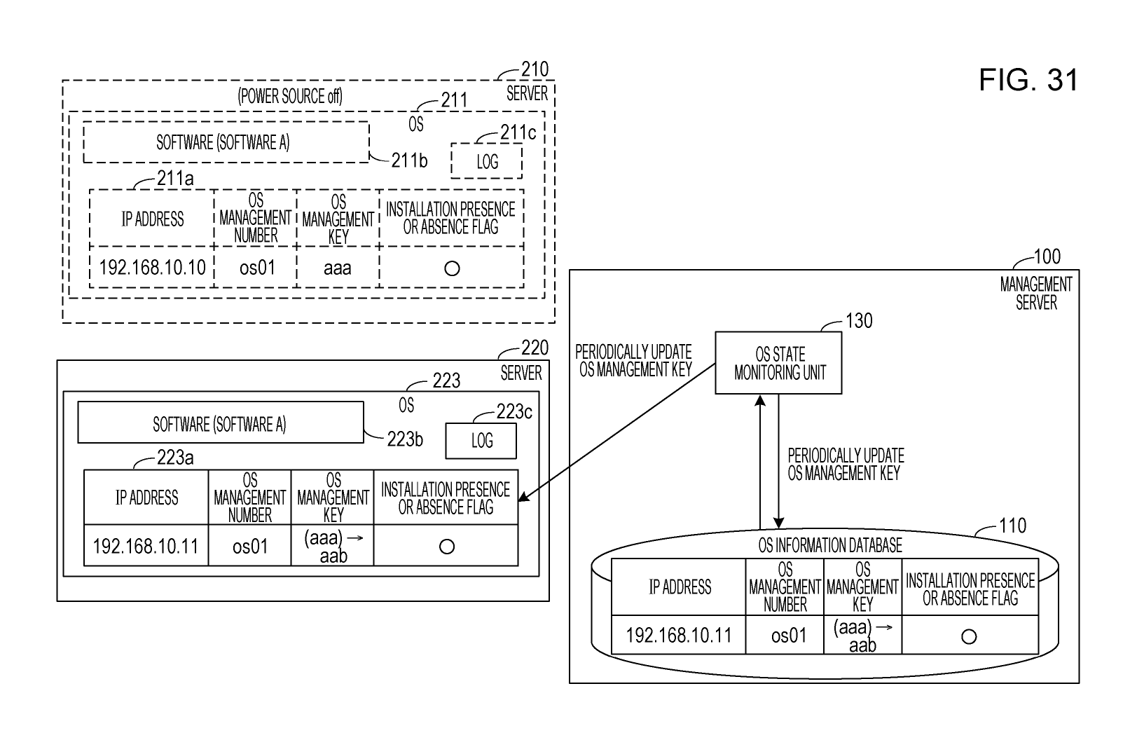

FIG. 31 is a diagram illustrating an example of the periodic update status of the OS management key after assignment of registered OS information to a copy destination OS. The OS state monitoring unit 130 acquires the record indicating the information of the OS already registered from the OS information database 110. Next, the OS state monitoring unit 130 writes the new OS management key in the registry 223a of the OS 223 corresponding to the IP address indicated in the acquired record. In the example of FIG. 31, the OS management key is updated from “aaa” to “aab”. Furthermore, the OS state monitoring unit 130 writes the OS management key newly set in the OS 223 in the section of the OS management key of the corresponding record in the OS information database 110.

Thereafter, it is assumed that the power source of the server 210 is turned on and the OS 211 is activated. By the processing illustrated in FIG. 30, the record currently registered in the OS information database 110 indicates the OS information of the OS 223. Therefore, after completion of activation of the OS 211, the user 31 inputs the registration instruction of the OS 211 to the management server 100.

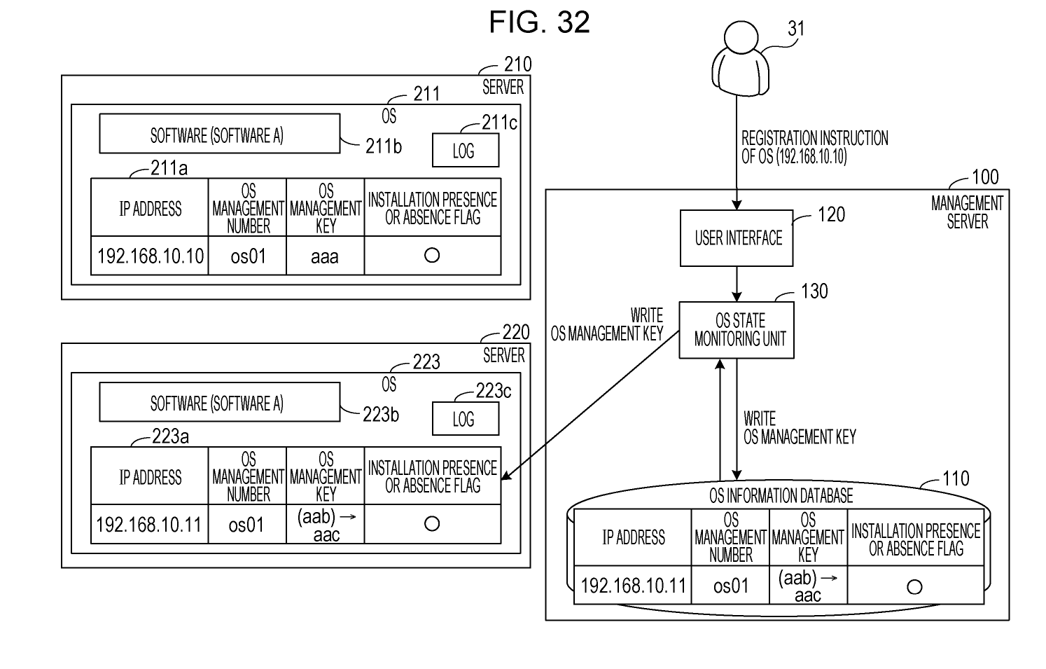

FIG. 32 is a first diagram illustrating an example of the registration status of the OS information after restart of the copy source OS. The user 31 inputs the registration instruction of the OS 211 in which the software 211b to be managed is installed in the user interface 120. The registration instruction includes the IP address of the OS 211. The input registration instruction is received by the user interface 120 and transferred to the OS state monitoring unit 130.

Firstly, the OS state monitoring unit 130 receiving the registration instruction acquires a record indicating OS information that is already registered from the OS information database 110. The OS state monitoring unit 130 writes the new OS management key in the registry 223a of the OS 223 corresponding to the IP address indicated in the acquired record. In the example of FIG. 32, the OS management key is updated from “aab” to “aac”. Furthermore, the OS state monitoring unit 130 writes the OS management key newly set in the OS 223 in the section of the OS management key of the corresponding record in the OS information database 110.

Thereafter, registration processing of the OS information in accordance with the registration instruction is performed.

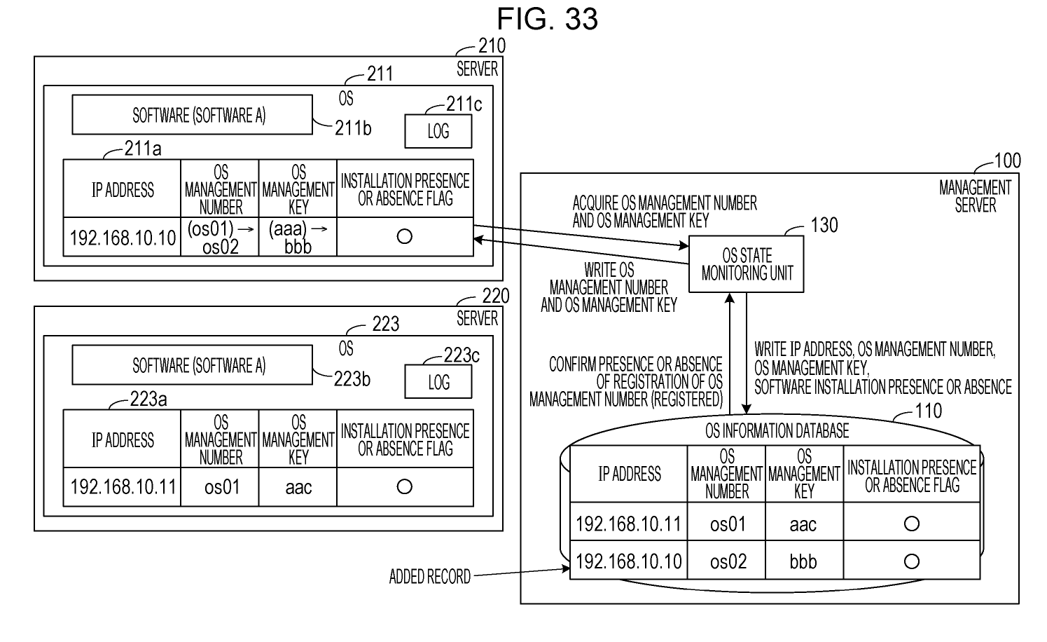

FIG. 33 is a second diagram illustrating an example of the registration status of the OS information after restart of the copy source OS. Firstly, the OS state monitoring unit 130 acquires the various information items of the OS management number, the OS management key, and the installation presence or absence flag from the registry 211a of the OS 211 to be managed. Next, the OS state monitoring unit 130 refers to the OS information database 110 and confirms whether the acquired OS management number is already registered. In the example of FIG. 33, the OS management number is unregistered at the confirmation stage.

In a case where the OS management number is not registered in the OS information database 110, the OS state monitoring unit 130 newly generates an OS management number and OS management key, and writes it in the registry 211a of the OS 211. Furthermore, the OS state monitoring unit 130 registers a new record including information on the software 211b registered in the registry 211a of the OS 211 in the OS information database 110. In the example of FIG. 33, the record in which an IP address “192.168.10.10” of the OS 211, an OS management number “os02”, an OS management key “bbb”, and the installation presence or absence flag “O” are set are registered in the OS information database 110.

As described above, in a case where a plurality of OSs having the same OS management number and OS management key exist due to copying of the virtual machine, the management server 100 is recognized that the OS where the information acquisition can be firstly performed is the OS is already recognized. Then, the management server 100 recognizes the OS that acquired the information later as a new OS.

In this manner, by combining the OS management key with the OS management number and appropriately updating the recognized OS management key, even in a case where the virtual machine including an OS is copied, the OS of the copy source and the OS of the copy destination are enable to distinguish from each other.

Processing Procedure Throughout

Hereinafter, a series of processing procedures in the second embodiment will be described more specifically. In addition, it is assumed that the installation of software corresponding to the OS of the number of licenses, and the software support contract between the customer company 30 and the service provider 40 is already completed.

First, the processing procedure when the OS information is registered in the management server 100 will be described in detail.

FIG. 34 is a sequence diagram illustrating a first half of a procedure of registration processing of the OS information. Hereinafter, the processing illustrated in FIG. 34 will be described along the step number.

Step S101

The user interface 120 acquires the OS registration instruction input by the user 31. The OS registration instruction includes the IP address of the OS to be registered.

Step S102

The user interface 120 transfers the acquired OS registration instruction to the OS state monitoring unit 130.

Step S103

The OS state monitoring unit 130 receiving the registration instruction of the OS transmits a request for calling all the records indicating the OS information to the OS information database 110.

Step S104

The OS information database 110 transmits all the records indicating the OS information to the OS state monitoring unit 130.

Step S105

The OS state monitoring unit 130 determines whether the OS information exists in the OS information database 110. For example, in a case where at least one record is received from the OS information database 110, the OS state monitoring unit 130 determines that there is OS information. In addition, in a case where the OS state monitoring unit 130 may not receive one record from the OS information database 110, the OS state monitoring unit 130 determines that there is no OS information. In a case where the OS information exists, the OS state monitoring unit 130 proceeds the processing to step S106. In addition, in a case where there is no OS information, the OS state monitoring unit 130 proceeds the processing to step S121 (see FIG. 35).

Step S106

The OS state monitoring unit 130 executes the processing of steps S107 to S110 by the number of records of the acquired OS information. That is, the OS state monitoring unit 130 selects the records acquired from the OS information database 110 one by one, and performs the processing of steps S107 to S110 on the selected record. In the example of FIG. 34, processing in a case where the record indicating the OS information of the OS 211 can be acquired is illustrated in steps S107 to S110.

Step S107

The OS state monitoring unit 130 generates a new OS management key, and writes the generated OS management key in the registry 211a of the OS 211 corresponding to the selected record. For example, the OS state monitoring unit 130 transmits a request to write the OS management key to the registry 211a to the OS 211.

Step S108

The OS 211 responds the result of writing to the registry 211a to the OS state monitoring unit 130. For example, the OS 211 responds to the normal ending of the write command in a case where the writing is successful. In addition, in a case where the writing fails, the OS 211 responds with an error message indicating a write failure.

Step S109

The OS state monitoring unit 130 determines whether the writing is successful based on the response of the writing result. For example, in a case where the OS state monitoring unit 130 receives the write success response from the OS 211, the OS state monitoring unit 130 determines that the writing is successful. In addition, in a case where the OS state monitoring unit 130 receives the response of the error message or in a case where the communication connection with the OS 211 is failed, the OS state monitoring unit 130 determines that the writing fails. In a case where the writing is successful, the OS state monitoring unit 130 proceeds the processing to step S110. In addition, in a case where the writing fails, the OS state monitoring unit 130 proceeds the processing to step S112.

Step S110

The OS state monitoring unit 130 writes the OS management key written in the registry 211a of the OS 211 in the record indicating the OS information of the OS 211 in the OS information database 110.

Step S111

After writing the OS management key, the OS information database 110 transmits the write result response indicating the writing success to the OS state monitoring unit 130.

Step S112

When the processing for all the records acquired from the OS information database 110 is completed, the OS state monitoring unit 130 proceeds the processing to step S121 (see FIG. 35).

FIG. 35 is a sequence diagram illustrating a second half of the procedure of registration processing of the OS information. Hereinafter, the processing illustrated in FIG. 35 will be described along the step number. It is assumed that the OS registration instruction includes the IP address of the OS 223.

Step S121

The OS state monitoring unit 130 acquires the OS management number, the OS management key, and the installation presence or absence flag from the registry 223a of the OS 223. For example, the OS state monitoring unit 130 transmits the read request for reading the OS management number, the OS management key, and the installation presence or absence flag in the registry 223a to the OS 223.

Step S122

In response to the read request, the OS 223 transmits the OS management number, the OS management key, and the installation presence or absence flag in the registry 223a to the OS state monitoring unit 130. As illustrated in FIG. 24, in the case of copying of other OSs, the OS management number and the OS management key are already set in the OS 223 at the time of OS registration instruction. On the other hand, if it is not copying the other OSs, the OS management number and OS management key are not set. In a case where the OS management number and the OS management key are not set in the registry 223a, the OS 223 transmits only the installation presence or absence flag to the OS state monitoring unit 130.

Step S123

The OS state monitoring unit 130 determines whether the OS management number and the OS management key are acquired. In a case where the OS management number and the OS management key can be acquired, the OS state monitoring unit 130 proceeds the processing to step S124. In a case where the OS management number and the OS management key may not be acquired, the OS state monitoring unit 130 proceeds the processing to step S131.

Step S124

The OS state monitoring unit 130 searches the record including the OS management number acquired from the OS 223 from the OS information database 110.

Step S125

The OS information database 110 transmits the record including the designated OS management number to the OS state monitoring unit 130 as a search result. In a case where there is no corresponding record, the OS information database 110 transmits a response indicating no record to the OS state monitoring unit 130.

Step S126

The OS state monitoring unit 130 determines whether the OS management number acquired from the OS 223 is registered in the OS information database 110. For example, in a case where the corresponding record is found by searching the OS information database 110, the OS state monitoring unit 130 determines that it is registered. If the OS management number acquired from the OS 223 is already registered, the OS state monitoring unit 130 proceeds the processing to step S127. In addition, the OS management number acquired from the OS 223 is unregistered, the OS state monitoring unit 130 proceeds the processing to step S131.

Step S127

The OS state monitoring unit 130 compares whether the OS management key acquired from the OS 223 matches the OS management key included in the acquired record from the OS information database 110.

Step S128

In a case where the OS management keys match to each other, the OS state monitoring unit 130 proceeds the processing to step S137. In addition, the OS management keys do not match to each other, the OS state monitoring unit 130 proceeds the processing to step S129.

Step S129

The OS state monitoring unit 130 notifies the user interface 120 of information indicating that a new OS management number is to be assigned.

Step S130

The user interface 120 displays a message indicating that a new OS management number is to be assigned on the monitor 21.

Step S131

The OS state monitoring unit 130 writes the OS management number and the OS management key in the registry 223a of the OS 223.

Step S132

The OS 223 transmits the response to the writing result of the OS management number and the OS management key to the OS state monitoring unit 130.

Step S133

The OS state monitoring unit 130 registers a new record in the OS information database 110. The record to be registered includes the IP address of the OS 223, the OS management number and the OS management key written in step S131, and the installation presence or absence flag obtained in the processing in steps S121 and S122.

Step S134

After writing the record, the OS information database 110 transmits the response of the write result to the OS state monitoring unit 130.

Step S135

The OS state monitoring unit 130 notifies the user interface 120 of the operation result.

Step S136

The user interface 120 displays the notified operation result on the monitor 21.

In a case where it is determined that the OS management keys do not match to each other in step S128, the OS information registration processing is ended. The following is the processing in a case where it is determined that the OS management keys match to each other in step S128.

Step S137

The OS state monitoring unit 130 notifies the user interface 120 that the IP address is to be changed.

Step S138

The user interface 120 displays a message indicating that the IP address is to be changed on the monitor 21.

Step S139

The OS state monitoring unit 130 changes the IP address of the record hit in the search in step S124 in the OS information database 110 to the IP address included in the registration instruction of the acquired OS information.

Step S140

The OS information database 110 writes the changed IP address in the corresponding record, and transmits the response of the write result to the OS state monitoring unit 130.

Step S141

The OS state monitoring unit 130 notifies the user interface 120 of the operation result.

Step S142

The user interface 120 displays the notified operation result on the monitor 21.

In this manner, the OS information of the OS indicated in the registration instruction is registered in the OS information database 110 according to the OS information registration instruction.

Next, periodic acquisition processing of information indicating the presence or absence of installation will be described.

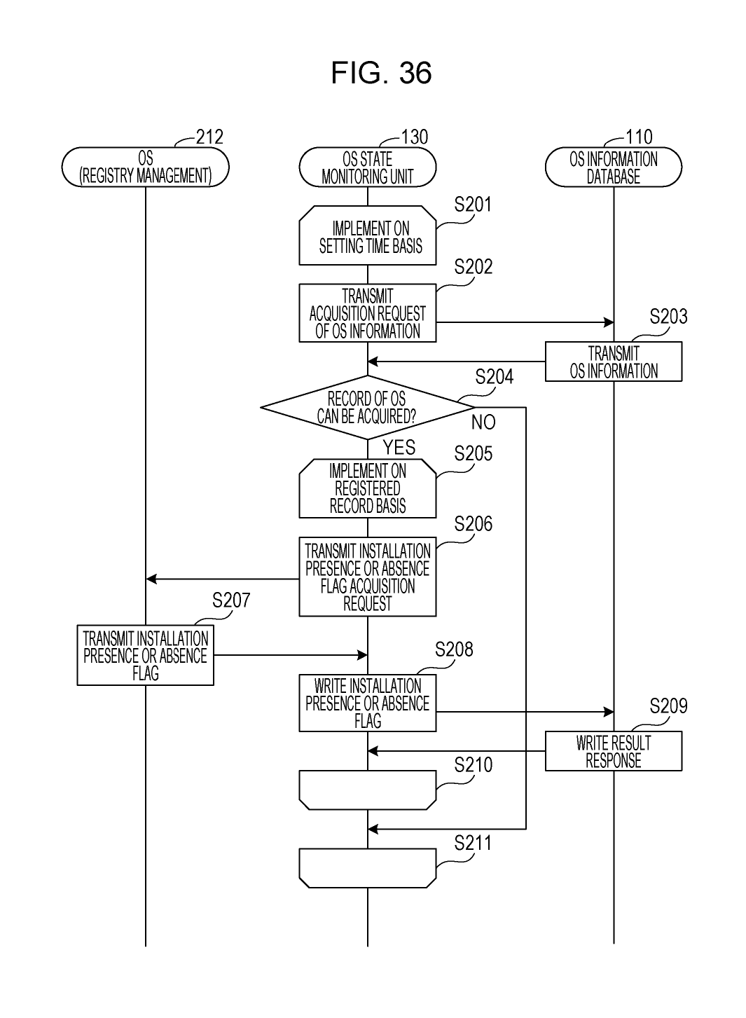

FIG. 36 is a sequence diagram illustrating an example of a procedure of installation information periodic acquisition processing. Hereinafter, the processing illustrated in FIG. 36 will be described along step numbers.

Step S201

The OS state monitoring unit 130 executes the processing of steps S202 to S210 on the predetermined time basis.

Step S202

The OS state monitoring unit 130 transmits the acquisition request of the record indicating registered OS information to the OS information database 110.

Step S203

The OS information database 110 transmits the record indicating the OS information to the OS state monitoring unit 130.

Step S204

The OS state monitoring unit 130 determines whether the record of the OS information is acquired. In a case where the record can be acquired, the OS state monitoring unit 130 proceeds the processing to step S205. In addition, in a case where the record may not be acquired, the OS state monitoring unit 130 proceeds the processing to step S211.

Step S205

The OS state monitoring unit 130 executes the processing of steps S206 to S210 for each record registered in the OS information database 110.

Hereinafter, the processing of steps S206 to S209 will be described assuming that the processing for the record indicating the information of the OS 212 is executed.

Step S206

The OS state monitoring unit 130 transmits the acquisition request of the installation presence or absence flag in the registry 212a of the OS 212 corresponding to the record to be processed.

Step S207

The OS 212 transmits the installation presence or absence flag in the registry 212a to the OS state monitoring unit 130.

Step S208

The OS state monitoring unit 130 transmits a write request of the installation presence or absence flag acquired from the OS 212 to the record corresponding to the OS 212 with respect to the OS information database 110.

Step S209

The OS information database 110 writes the installation presence or absence flag and transmits the response indicating the write result to the OS state monitoring unit 130.

Step S210

In a case where the processing for all the records acquired from the OS information database 110 is completed, the OS state monitoring unit 130 proceeds the processing to step S211.

Step S211

When the user 31 inputs the instruction to end the periodic acquisition processing of the installation information, for example, the OS state monitoring unit 130 ends the execution of the repetition processing of steps S202 to S210.

In this manner, for example, as illustrated in FIG. 14, the information indicating whether the software is installed in each server is acquired by the management server 100 and reflected in the OS information database 110.

Next, the periodic update processing procedure of the OS management key will be described.

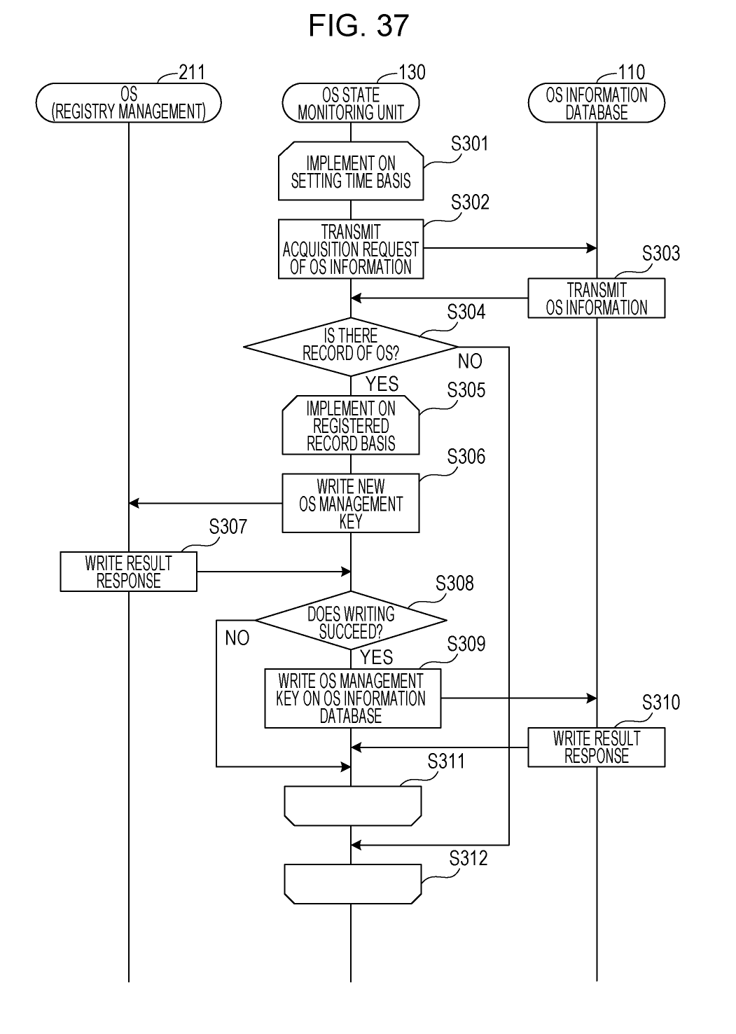

FIG. 37 is a sequence diagram illustrating an example of a procedure of OS management key periodic update processing. Hereinafter, the processing illustrated in FIG. 37 will be described along the step number.

Step S301

The OS state monitoring unit 130 executes the processing of steps S302 to S311 on the predetermined time basis.

Step S302

The OS state monitoring unit 130 transmits the acquisition request of the record indicating the registered OS information to the OS information database 110.

Step S303

The OS information database 110 transmits a record indicating the OS information to the OS state monitoring unit 130.

Step S304

The OS state monitoring unit 130 determines whether the record of the OS information can be acquired. In a case where it is difficult to acquire the record, the OS state monitoring unit 130 proceeds the processing to step S305. In addition, in a case where it is difficult to acquire the record, the OS state monitoring unit 130 proceeds the processing to step S312.

Step S305

The OS state monitoring unit 130 executes the processing of steps S306 to S310 for each record registered in the OS information database 110.

Hereinafter, the processing of steps S306 to S309 will be described assuming that the processing for the record indicating the information of the OS 211 is executed.

Step S306

The OS state monitoring unit 130 generates a new OS management key and transmits a request to write a new OS management key to the registry 211a of the OS 211 to the OS 211.

Step S307

The OS 211 writes the OS management key in the registry 211a, and transmits a response indicating the write result to the OS state monitoring unit 130.

Step S308

The OS state monitoring unit 130 determines whether writing of the OS management key is successful. If the writing is successful, the OS state monitoring unit 130 proceeds the processing to step S309. In addition, in a case where the writing fails, the OS state monitoring unit 130 proceeds the processing to step S311.

Step S309

The OS state monitoring unit 130 transmits the writing request of a new OS management key to the record corresponding to the OS 211 with respect to the OS information database 110.

Step S310

The OS information database 110 writes the OS management key, and transmits the response indicating the write result to the OS state monitoring unit 130.

Step S311

In a case where the processing for all the records acquired from the OS information database 110 is completed, the OS state monitoring unit 130 proceeds the processing to step S312.

Step S312

When the user 31 inputs an ending instruction to the periodical acquisition processing of the OS management key, for example, the OS state monitoring unit 130 ends the execution of the repetition processing of steps S302 to S311.

In this manner, the OS management key of each OS is periodically updated.

Next, processing in a case where the bug occurs in software and the support service is requested will be described. In a case of requesting the support service, the system on the customer company 30 side performs the OS management number specification processing and the encryption file generation processing.

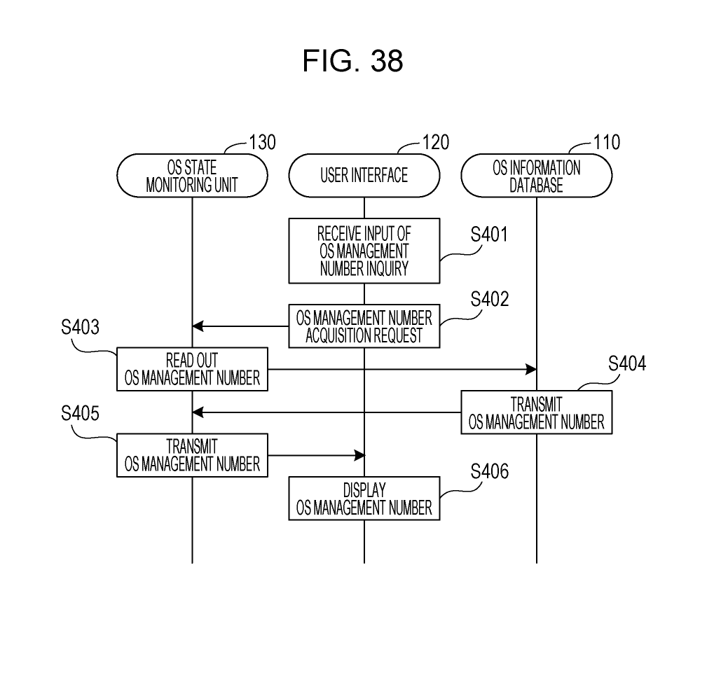

FIG. 38 is a flowchart illustrating an example of a procedure of OS management number specification processing. Hereinafter, the processing illustrated in FIG. 38 will be described along the step number.

Step S401

The user interface 120 receives the input of the OS management number inquiry from the user 31.

Step S402

The user interface 120 transmits the OS management number acquisition request designating the IP address indicated by the OS management number inquiry to the OS state monitoring unit 130.

Step S403

The OS state monitoring unit 130 transmits a read request of the OS management encryption designating the IP address to the OS information database 110.

Step S404

The OS information database 110 reads out the OS management number from the record including the designated IP address, and transmits the read OS management number to the OS state monitoring unit 130.

Step S405

The OS state monitoring unit 130 transmits the acquired OS management number to the user interface 120.

Step S406

The user interface 120 displays the OS management number sent from the OS state monitoring unit 130 on the monitor 21 as a processing result according to the OS management number inquiry.

Accordingly, the user 31 can recognize the OS management number of the OS in which the software in which the bug occurs is installed. When the user 31 designates the OS management number and inputs the log acquisition instruction to the management server 100, the encryption file generation processing is executed.

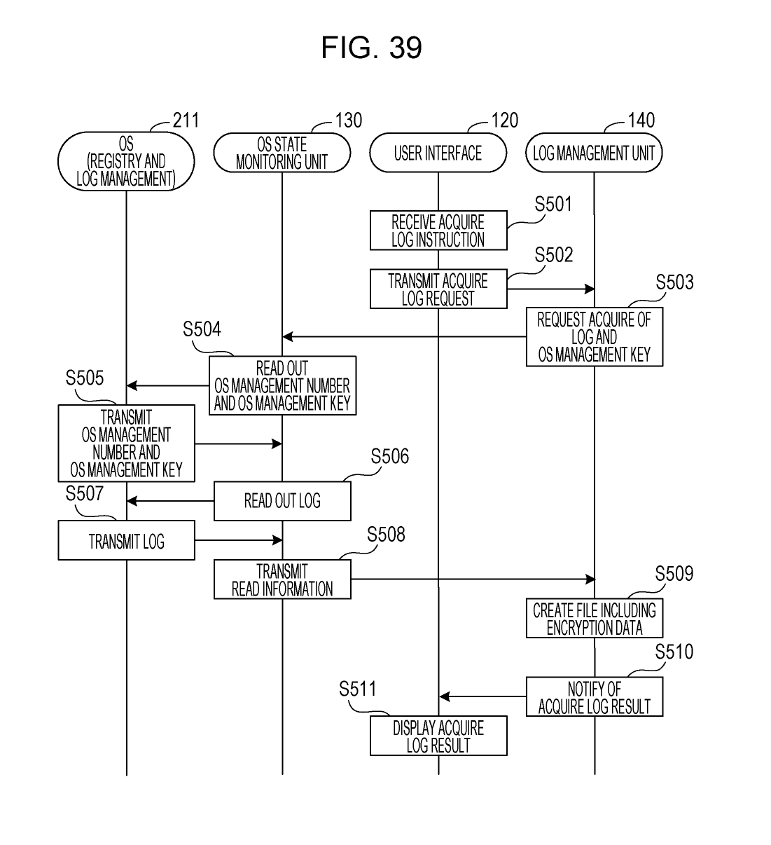

FIG. 39 is a flowchart illustrating an example of a procedure of encryption file generation processing. Hereinafter, the processing illustrated in FIG. 39 will be described along the step number.

Step S501

The user interface 120 receives the input of the log acquisition instruction from the user 31.

Step S502

The user interface 120 transmits the log acquisition request designating the OS management number to the log management unit 140.

Step S503

The log management unit 140 transmits the request to acquire the log and the OS management key designating the OS management number to the OS state monitoring unit 130.

Step S504

The OS state monitoring unit 130 transmits the read request for reading the OS management number and the OS management key to the OS 211 corresponding to the designated OS management number.

Step S505

The OS 211 reads out the OS management number and the OS management key from the registry 211a, and transmits the read OS management number and the OS management key to the OS state monitoring unit 130.

Step S506

The OS state monitoring unit 130 transmits a request to read the log 211c to the OS 211.

Step S507

The OS 211 reads out the log 211c and transmits the read log 211c to the OS state monitoring unit 130.

Step S508

The OS state monitoring unit 130 transmits the read OS management number, OS management key, and log 211c to the log management unit 140.

Step S509

The log management unit 140 encrypts the OS management number, the OS management key, and the log 211c to generate the encryption data. The log management unit 140 generates the file including the generated encryption data. The log management unit 140 stores the generated file in the processing location.

Step S510

The log management unit 140 notifies the user interface 120 of the log acquisition result.

Step S511

The user interface 120 displays the log acquisition result on the monitor 21. For example, the storage location of the file including the encrypted OS management number, the OS management key, and the log 211c is displayed on the monitor 21.

When support requesting to the support representative 41, the user 31 notifies the support representative 41 of the OS management number and the contents of the bug and also hands the file including the encrypted log 211c to the support representative 41. The support representative 41 determines whether the bug software is a subject of the support contract using the received file.

In the examples illustrated in FIGS. 18 to 22, the support representative 41 itself determine whether the support representative 41 is the target of the support contract. However, the support contract management server 300 can also execute the determination. Hereinafter, a procedure of processing (support contract confirmation processing) for determining whether to support or not by the support contract management server 300 will be described.

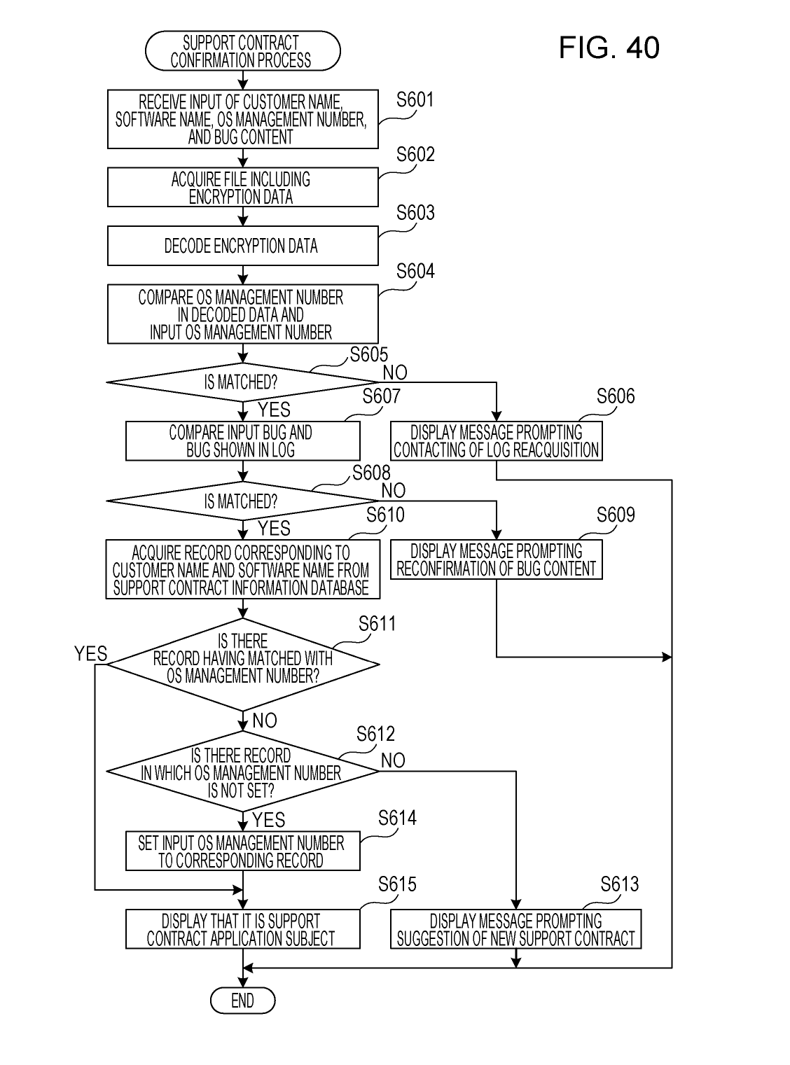

FIG. 40 is a flowchart illustrating an example of a procedure of support contract confirmation processing. Hereinafter, the processing illustrated in FIG. 40 will be described along the steps.

Step S601

The support contract management unit 320 receives input of the customer name, the software name, the OS management number, and the contents of the bug. For example, the support representative 41 inputs information such as a customer name in a predetermined field in the screen displayed by the support contract management unit 320. The information transmitted from the user 31 at the time of requesting the support is input as the OS management number and the bug contents. The bug content is, for example, an error code displayed at the time of bug occurrence. The support contract management unit 320 acquires each of information items input in a predetermined field.

Step S602

The support contract management unit 320 acquires the file including encrypted data. For example, the support representative 41 stores the file in the storage device of the support contract management server 300 and inputs the storage location of the file. The support contract management unit 320 acquires the file from the input location.

Step S603

The support contract management unit 320 decrypts the encryption data in the acquired file. By decrypting the encryption data, the OS management number, the OS management key, and the log can be acquired.

Step S604

The support contract management unit 320 compares the OS management number in the decrypted data with the OS management number input in step S601.

Step S605

In the comparison in step S604, the support contract management unit 320 determines whether the OS management numbers match to each other. When the OS management numbers match, the support contract management unit 320 proceeds the processing to step S607. In addition, if the OS management numbers do not match each other, the support contract management unit 320 proceeds the processing to step S606.

Step S606

The support contract management unit 320 displays a message prompting contacting of log reacquisition of on the monitor. The support representative 41 confirms the displayed message, recognizes that the source of acquisition of the log received from the user 31 is incorrect, and requests the user 31 to acquire the correct log again. Thereafter, the support contract confirmation processing is ended.

Step S607

The support contract management unit 320 compares the input bug contents with the bug contents indicated in the log. For example, the support contract management unit 320 compares error codes indicating the details of the bug.

Step S608

The support contract management unit 320 determines whether the bug contents match with each other. In a case where the bug contents coincide, the support contract management unit 320 proceeds the processing to step S610. In addition, in a case where the bug contents do not match with each other, the support contract management unit 320 proceeds the processing to step S609.

Step S609

The support contract management unit 320 displays a message prompting reconfirmation of the bug contents on the monitor. The support representative 41 confirms the displayed message, recognizes that the source of the log received from the user 31 or recognizes that the content of the notified bug is incorrect, and causes the user 31 to reconfirm the contents of the bug. Thereafter, the support contract confirmation processing is ended.

Step S610

The support contract management unit 320 acquires a record corresponding to the set of the input customer name and software name from the support contract information database 310.

Step S611

The support contract management unit 320 determines whether or not there is a record having an OS management number that matches the input OS management number among the acquired records. If there is the corresponding record, the support contract management unit 320 proceeds the processing to step S615. In addition, if there is no corresponding record, the support contract management unit 320 proceeds the processing to step S612.

Step S612

The support contract management unit 320 determines whether or not there is the record for which an OS management number is set among the acquired records. If there is a corresponding record, the support contract management unit 320 proceeds the processing to step S614. In addition, if there is no corresponding record, the support contract management unit 320 proceeds processing to step S613.

Step S613

The support contract management unit 320 displays a message prompting to a suggestion of a new support contract on the monitor. By confirming the displayed message, the support representative 41 recognizes that the number of software of the target of the support contract is insufficient and suggests a new support contract to the user 31. Thereafter, the support contract confirmation processing is ended.

Step S614

The support contract management unit 320 sets the input OS management number in one of the acquired records, in which the OS management number is not set. The support contract management unit 320 writes the record in which the OS management number is set back to the support contract information database 310.

Step S615

The support contract management unit 320 displays that the software to be supported on the support request is the application target of the support contract on the monitor. The support representative 41 confirms the display indicating that the support contract is applicable and implements the support to the user 31. Thereafter, the support contract confirmation processing is ended.

As described above, according to the second embodiment, even in a case where the software is installed on the virtual machine, the individual can be specified and can be associated with the support contract. As a result, when the user 31 requests the support representative 41 for support, the support representative 41 can determine whether the inquiry content of the user is correct and can take appropriate countermeasures.

Furthermore, even if the virtual machine is copied, the management server 100 can recognize that the OSs operating in the virtual machines of the copy source and the copy destination are different entities and assign the OS management numbers to each entity. According to this, even in a case where the virtual machine is copied, it is possible to avoid support for both of the copy source software and the copy destination software with the support contract for one software.

### Other Embodiments

In the second embodiment, in the example illustrated in FIG. 17, the user 31 individually performs the inquiry of the OS management number and the log acquisition instruction relating to the OS. However, it is only desirable to perform these inputs only once. For example, the user 31 inputs the log acquisition instruction specifying the IP address of the OS. The user interface 120 receives the log acquisition instruction and transmits the log acquisition request specifying the IP address to the log management unit 140. The log management unit 140 specifies the IP address, and transmits the OS management number, the OS management key, and the log acquisition request to the OS state monitoring unit 130. The OS state monitoring unit 130 acquires the OS management number and the OS management key from the registry of the OS corresponding to the IP address. In addition, the OS state monitoring unit 130 acquires the log of the software from the OS corresponding to the IP address. The OS state monitoring unit 130 transmits the acquired OS management number, OS management key, and log to the log management unit 140. The log management unit 140 encrypts the acquired OS management number, the OS management key, and the log, and generates a file including the encryption data. The log management unit 140 transmits the response of the log acquisition completion to the user interface 120. The user interface 120 displays that storage of the file including the log is completed on the monitor 21. In this manner, it is possible to reduce the labor of input by the user 31 when generating the encryption data including the log.

In the second embodiment, the IP address is used as the information for specifying the OS on the network. However, the OS may be specified by other information. For example, in a case where an individual identification number is set in the OS, the OS can be specified by the individual identification number.

Hereinabove, the embodiments are exemplified. However, the configuration of each unit discussed in the embodiments can be replaced with another configuration having the same function. In addition, any other configuration articles or processes may be added. Furthermore, any two or more configurations (features) of the above-described embodiments may be combined.

Regarding the above embodiments, the following appendixes will be disclosed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device comprising:
a memory configured to store a record corresponding to an operating system recognized as being executed on a computer to be managed; and
a processor coupled to the memory and configured to:
when recognizing existence of a first operating system being executed on the computer to be managed, write a first identifier and a first management key corresponding to the first operating system to a first storage area storing setting information of the first operating system, store a first record including a set of the first identifier and the first management key to the memory, and rewrite the first management key included in each of the first storage area and the first record as a second management key having a value different from that of the first management key at a predetermined timing, and
when recognizing existence of a second operating system being executed on the computer to be managed, acquire an identifier and a management key from a second storage area storing setting information of the second operating system, when a value of the acquired identifier matches a value of the first identifier and a value of the acquired management key does not match the value of the second management key, rewrite the identifier in the second storage area as a second identifier having a value different from that of the first identifier, rewrite the management key in the second storage area as a third management key having a value different from that of the second management key, and store a second record including a set of the second identifier and the third management key corresponding to the second operating system in the memory.

2. The information processing device according to claim 1,
wherein the processor is configured to periodically execute change of the first management key to the second management key at predetermined time intervals.

3. The information processing device according to claim 1,
wherein the processor is configured to execute the change of the first management key to the second management key after recognizing the existence of the second operating system and before rewriting the identifier in the second storage area as the second identifier.

4. The information processing device according to claim 1,
wherein, in a case where the value of the acquired identifier matches the value of the first identifier and the value of the acquired management key matches the value of the first management key, the processor rewrites the management key in the second storage area and the first management key in the first record as a fourth management key having a value different from that of the first management key.

5. A non-transitory, computer-readable recording medium having stored therein a program for causing a computer including a memory to execute a process comprising:
when recognizing existence of a first operating system being executed on the computer to be managed, writing a first identifier and a first management key corresponding to the first operating system on a first storage area storing setting information of the first operating system, storing a first record including a set of the first identifier and the first management key to the memory, and rewriting the first management key included in each of the first storage area and the first record as a second management key having a value different from that of the first management key at a predetermined timing; and
when recognizing existence of a second operating system being executed on the computer to be managed, acquiring an identifier and a management key from a second storage area storing setting information of the second operating system, in a case where a value of the acquired identifier matches a value of the first identifier and a value of the acquired management key does not match the value of the second management key, rewriting the identifier in the second storage area as a second identifier having a value different from that of the first identifier, rewriting the management key in the second storage area as a third management key having a value different from that of the second management key, and storing a second record including a set of the second identifier and the third management key corresponding to the second operating system in the memory.

6. The non-transitory, computer-readable recording medium of claim 5, the process further comprising:
in a case where the value of the acquired identifier matches the value of the first identifier and the value of the acquired management key matches the value of the first management key, rewriting the management key in the second storage area and the first management key in the first record as a fourth management key having a value different from that of the first management key.

7. An information processing method comprising:
when recognizing existence of a first operating system being executed on a computer to be managed, writing a first identifier and a first management key corresponding to the first operating system of a first virtual machine in a first storage area storing setting information of the first operating system, storing a first record including the first identifier and the first management key to a memory, and rewriting the first management key included in each of the first storage area and the first record to a second management key different from the first management key at a predetermined timing;
when recognizing existence of a second operating system being executed on the computer to be managed, acquiring an identifier and a management key from a second storage area storing setting information of the second operating system of a second virtual machine, when the acquired identifier matches the first identifier and the acquired management key does not match the second management key, rewriting the identifier in the second storage area as a second identifier different from that of the first identifier, rewriting the management key in the second storage area as a third management key different from that of the second management key, and storing a second record including the second identifier and the third management key corresponding to the second operating system in the memory;
transmitting a request for software support including one of the first identifier and the second management key for the first operating system or the second identifier and the third management key for the second operating system;
receiving an indication, on a display device, whether software support is available for the first operating system or the second operating system based on the identifier and the management key.

8. The information processing method of claim 7, further comprising:
receiving software support for the first operating system or the second operating system in response to the request for software support.

9. The information processing method of claim 7, further comprising:
receiving an indication, on the display device, that software support for the first operating system or the second operating system is suggested in response to the request for software support.
